(19) United States
(12) Patent Application Publication
(10) Pub. No.: US 2019/0318283 A1
(43) Pub. Date: Oct. 17, 2019

(54) SYSTEM AND METHOD FOR ADAPTIVELY EXECUTING USER ROUTINES BASED ON USER INTERACTIONS

(71) Applicant: CROSSWIND COMMUNICATIONS, West Newbury, MA (US)

(72) Inventors: James P. Kelly, West Newbury, MA (US); Bruce A. Sharpe, Aurora, CO (US)

(21) Appl. No.: 16/262,745

(22) Filed: Jan. 30, 2019

Related U.S. Application Data
(60) Provisional application No. 62/656,974, filed on Apr. 12, 2018.

(51) Int. Cl. G06Q 10/06; G08B 21/24; G06Q 10/10; G06N 20/00

(52) U.S. Cl. CPC G06Q 10/0633; G08B 21/24; G06K 9/00288; G06N 20/00; G06Q 10/1095

(57) ABSTRACT

For each workflow, processing logic determines a current time of the day and identifies a workflow stage corresponding to the time of the day, and retrieves a content item corresponding to the workflow stage. The content item is transmitted to one or more user devices of the user to be presented thereon. A response is received from at least one of the user devices representing a user response to the content item. The user response and time of the response are recorded in an event log that stores the user interaction history of the user. Subsequently, a machine-learning engine is invoked to perform an analysis on the user interaction history in the event log to determine user routine pattern of the user for each workflow. Timing as well as other parameters of one or more subroutines of the workflows may be modified based on the analysis.

### RELATED APPLICATIONS

This application claims the benefit of U.S. provisional patent application No. 62/656,974, filed Apr. 12, 2018, which is incorporated by reference herein in its entirety.

### TECHNICAL FIELD

Embodiments of the invention relate generally to data processing and event notification. More particularly, embodiments of the invention relate to processing and handling emergency events of users.

### BACKGROUND

Healthy habits are a key to living and ageing well and include sufficient sleep, a nutritious diet, preventative care, exercise, hygiene, and social engagement. Typically, visitors are scheduled to visit the premises in which an individual resides. Such an arrangement sometimes cannot provide sufficient services to the individual. There has been a lack of efficient systems to keep track and help enforcing the healthy habits for individuals to age at home.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an example of a networked system according to one embodiment of the invention.

FIG. 2 is a block diagram illustrating an example of a routine management system according to one embodiment of the invention.

FIG. 3 is a block diagram illustrating an example of a routine management system according to another embodiment of the invention.

FIGS. 4A and 4B are block diagrams illustrating examples of user registries according to certain embodiments of the invention.

FIG. 5 shows an example of a device registry according to one embodiment of the invention.

FIG. 6 is a block diagram illustrating an example of a primary user premise according to one embodiment of the invention.

FIG. 7 is a diagram illustrating an example of a routine according to one embodiment of the invention.

FIG. 8 is a process flow diagram illustrating an example of interactions amongst parties of routine management according to one embodiment of the invention.

FIG. 9 is a flow diagram illustrating a process of execution of a routine according to one embodiment of the invention.

FIG. 10A is a process flow diagram for handling a panic routine for a primary user according to one embodiment of the invention.

FIG. 10B is a flow diagram illustrating an example of a process for handling an emergency event according to another embodiment of the invention.

FIGS. 11A and 11B are flow diagrams illustrating examples of processes for handling an emergency event according to certain embodiments of the invention.

FIG. 12 is a block diagram illustrating an example of a medication routine service according to one embodiment of the invention of the invention.

FIG. 13 is a flow diagram illustrating an example of a process of enforcing a routine associated with a user according to one embodiment of the invention.

FIG. 14 is a screenshot illustrating an example of a graphical user interface (GUI) for configuring a morning routine according to one embodiment of the invention.

FIG. 15 is a screenshot illustrating an example of a graphical user interface (GUI) for configuring a medication intake routine according to one embodiment of the invention.

FIG. 16 is a screenshot illustrating an example of a graphical user interface for configuring a vital measure routine according to one embodiment of the invention.

FIGS. 17A and 17B are screenshots illustrating an appointment template to configure an appointment routine according to one embodiment of the invention.

FIG. 18 is a screenshot illustrating an example of a graphical user interface for configuring an assist routine according to one embodiment of the invention.

FIGS. 19A and 19B are screenshots illustrating a graphical user interface of reporting user activities according to certain embodiments of the invention.

FIG. 20 is a block diagram illustrating a data processing system according to one embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a system is provided to monitor the safety and wellbeing of individuals wishing to age in place and to provide an environment for the development and maintenance of habits for ageing well. Caregivers, family members, and others in the CareCircle are kept well informed and can provide assistance when required, as well as plan for in-person services and visits. Healthy habits are a key to extended living and ageing well and include sufficient sleep, a nutritious diet, preventative care, exercise, hygiene, and social engagement. The system provides an automated, monitored, measured, and managed environment to ensure that the individual is safe and secured, and to create and reinforce positive habits, and that loved ones and caregivers are comforted through being informed where they were not previously.

The system aggregates data regarding an individual activities, well-being and environment from a variety of sensors (e.g., Internet of Things or IoT-based sensors) worn by and/or within the residency of the individual. This data is placed in a data store and acted upon by various heuristics, workflows, and adaptive routines. It can also be presented in various reports and visual displays. Individuals interact with the system through a variety of networked devices such as mobile devices and wearable devices that have been optimized for variations in vision, hearing, motor-control, and cognition.

The system maintains a number of routines that can be user configurable by authorized personnel. The routines can include one or more of a morning routine, a night routine, a nutrition routine, a medication routine, a vital measurement routine, an appointment routine, a visitor reminder routine, and an assistance routine. Each of these routines can be configured in a form of workflows and each workflow includes one or more workflow stages that can be executed at different points in time, in series or in parallel. These routines, when executed, would help an individual throughout the day. In addition, a CareCircle routine, also referred to as a help or emergency routine, may also be configured, which can be triggered in response to a live assisted request from a user. The CareCircle routine is preconfigured and setup to be triggered from a number of soft or hard button end points within their environment. These routines are executed to perform different operations in conjunction with sensor data obtained from a variety of sensors disposed within a premise of an individual (e.g., their home or an assisted living facility). The sensor data can be utilized to track the user activities, interactions, and confirmation of the user actions, etc. As a result, the user can easily follow the healthy habits and live in a healthy environment.

According to one aspect of the invention, a first message is received at a first server from a primary device of a primary user located within a primary location over a network. In response to the first message, a primary user identifier (ID) is determined based on a first device ID extracted from the first message, where the first device ID identifies the primary device. Based on the primary user ID, a user database is queried to identify a group of one or more secondary users, where the secondary users may be related to or associated with the primary user. The user database is maintained by the first server and configured by an administrator associated with the primary user. A set of one or more secondary user IDs is obtained from the user database based on the query. The secondary user IDs are then transmitted to a second server over the network to request the second server to send an SMS message to each and establish a conference (e.g., audio or video conference) over the network amongst one or more secondary user devices of the one or more secondary users, optionally with the primary user device. As a result, the secondary users can discuss an event associated with the first message of a first user.

According to one embodiment, the first server periodically monitors and receives messages from a number of devices or sensors associated with a number of users located at various locations. Each message represents an event occurred at a respective one of the locations. The primary user is one of the users and the primary device is one of the devices monitored. In one embodiment, the first server periodically receives messages or signals from a number of devices disposed at various locations within the primary location of the primary user. Each message represents an event occurred at the primary location.

According to one embodiment, location information concerning the primary location is obtained from the user database based on the primary user ID. The location information is then transmitted to a third server to request a third user to be dispatched to visit the primary location. The third user may be an emergency medical service (EMS) person. The secondary users may be specified and stored in a user account associated with the primary user in the user database, which may be configured previously by an authorized person authorized by the primary user via a configuration interface. The first message may be initiated by the primary user via a CareCircle assist button of a CareCircle assist device (also referred to as a panic button of a panic device). The primary location may represent a home or an assisted living facility.

According to another aspect of the invention, a server maintains one or more workflows for managing daily routines of a user located at a premise. Each workflow includes one or more workflow stages. Each workflow stage is associated with a subroutine configured to be executed at a particular time of a day. Processing logic hosted by the server periodically examines each workflow stage of each workflow to execute the corresponding subroutine of the workflow stage. Specifically, for each of the workflows, processing logic determines a current time of the day and identifies a workflow stage corresponding to the time of the day. Processing logic retrieves a content item corresponding to the workflow stage. The content item is transmitted to one or more preconfigured user devices of the user to be presented and played thereon. A response is received from at least one of the preconfigured user devices representing a user response to the content item. The user response and time of the response are recorded in an event log that stores the user interaction history of the user. Subsequently, a machine-learning engine is invoked to perform an analysis on the user interaction history in the event log to determine a user behavior or user routine pattern of the user for each workflow. Timing as well as other parameters of one or more subroutines of the workflows may be modified based on the analysis.

In one embodiment, a routine can be a morning wakeup call to alert an user and the content item may include media content to play (e.g. weather, news, music, other) once determined the individual has woke up from sleep. Once the wakeup message has been sent to the user device, the system monitors one or more motion sensors disposed within the premise of the user (e.g., individual). In response to one or more signals received from the motion sensors, which indicates that the user has woke up and moved about, the system records the wakeup time. In addition, the routine may follow up with a query to the user regarding whether the user has a normal day of activities. Based on the feedback from the user, if there is something unusual detected, the routine may initiate another routine, for example, contacting another user to visit the primary user. The wakeup time can be stored in an event log of the user, which is part of the user daily routine history. In one embodiment, during the day, if there is no signal received from the motion sensors for a predetermined period of time, the system may transmit another reminder to the user device or devices to prompt the user to get up and move around as a part of an exercise subroutine.

According to another embodiment, a smart doorbell may be installed at a front door of the premise of the user and the smart doorbell may be monitored by the system remotely. When a visitor is approaching the front door of the premise of the user and presses the door bell, a signal is transmitted back to the monitoring system over a network. In addition, an image of the visitor may be captured by a camera of the doorbell. In response to the signal, the system may access a calendar system to examine calendar data or routines associated with the user to determine whether there should be visitor visiting the user at the point in time. If so, the system may further compare the image of the visitor received from the doorbell and the one stored in a contact store maintained internally to determine whether the visitor at the front door is the one expected. The system may transmit a message to the user device to notify the user whether there is someone expected to visit the user. The message may further include the identifying information of the visitor, including the name, organization, and/or the image of the visitor, as well as the reason or description of the visit. Such screening and validation provides a level of security from door to door scammers or individuals intended on doing harm.

According to a further embodiment, the system periodically accesses a calendar system to determine whether there is an appointment that has been scheduled at certain points in time of a particular day according to an appointment routine. If so, the system may transmit a reminder to the user device to prompt the user of the pending appointment. The system may further examine whether the user needs help to arrange transportation. If so, the system automatically contacts a predetermined facility (e.g., taxi or ride sharing companies) to arrange the transportation to the users premise for pickup and provide transportation to the appointment location.

According to a further aspect of the invention, a medication routine can be enforced using an efficient monitoring system. For each day, a preconfigured medication intake routine is executed, where the routine is specifically configured for a user residing at a premise. The routine includes a number of actions or subroutines to be performed or executed at different points in time of the day. The actions can be specific reminders to be sent to the user to prompt the user to take specific medication. Given the specific time of the day, the system examines the routine to determine whether a medicine pill or medication has been scheduled around a specific time. If so, the system transmits a first message to one or more user devices of the user to prompt the user to take the medication specifically configured for that time of the day.

The first message may include information identifying the medication to be taken, such as the name and/or a picture of the medicine. The medication or pill may be stored within a pill dispenser, particularly a smart pill dispenser. When the user removes the pill from the pill dispenser, a signal is transmitted back to the system over the network. The signal may be utilized as an indication that the user has correctly taken the scheduled medicine. Once the signal has been received from the pill dispenser, the system may record the time of receiving the signal as the time at which the user has taken the medicine.

According to one embodiment, the pill dispenser may include a number of pill slots and each slot may be used to store one or more pills for a specific time. Each slot may be associated with a sensor such as a pressure or light sensor to sense whether the corresponding pill or pills have been removed from the slot. When a pill has been removed from a particular pill slot, a signal is sent by a corresponding slot sensor to the monitoring system. The system can determine whether the appropriate pill for that particular time has been removed from the slot. That is, the signal is used to determine whether the user has taken the medication as scheduled. If the medication taken does not match the one as expected, the system may send a further message to the user device to ask the user to confirm to make sure that the user has taken the correct medicine.

According to another embodiment, as a part of medical or vital measurement procedures, the system may transmit a reminder to the user device to prompt the user to perform some vital measurements, such as blood pressure, heartrate, weight, or sugar level, etc. Some of these data, such as heartrate, step counts, sleep, blood pressure, may be automatically collected from the vital measurement devices worn by the user or put on in response to the reminder message. The date and the time of the measurements may be stored in an event log or data store for further analysis. Furthermore, certain motion sensors can also be utilized to sense and determine when the user goes to bed or the time the user falls asleep. The motion sensors can also be utilized to sense that the user has been idle for a period of time and that the user needs to move around or do some exercises. The system automatically receives the signals from variety of sensors and makes a proper decision to prompt the user to do something. Similarly, the system can communicate with the user to offer help on other tasks, such as turning on a TV or radio or turning to a specific channel of the TV or radio, or reminding the user to have meals at different times of the day.

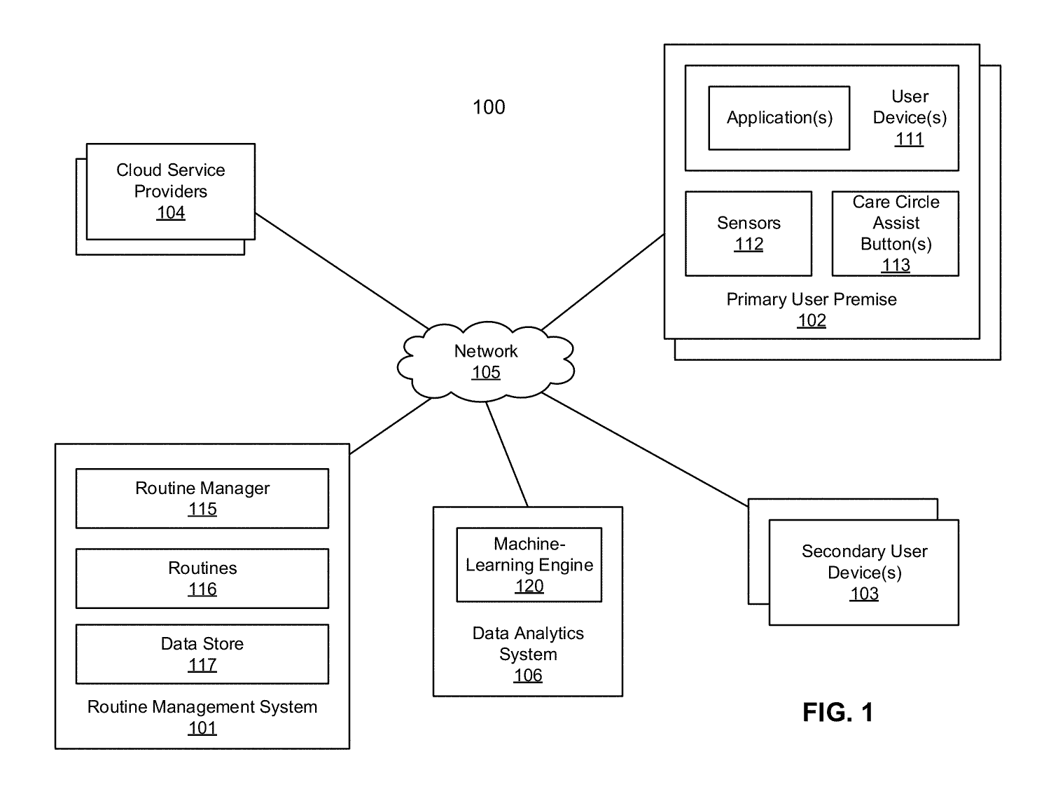

FIG. 1 is a block diagram illustrating an example of a networked system according to one embodiment of the invention. Referring to FIG. 1, system 100 includes a routine management system 101 communicatively coupled to one or more primary user premises or facilities 102 and one or more secondary user devices 103 over network 105. Network 105 may be a local area network (LAN), a wide area network (WAN), or a combination of both, wired and/or wireless. Routine management system 101 may be hosted in a server or a cluster of servers, which may be a Web server, a cloud server, an application server, and/or a backend server. Primary user premises or facilities 102 may be a part of a user's home or an assisted living facility. A primary user refers to a person such as an individual who resides and lives in the premise most of the time and receives care from a family member or professional caregiver.

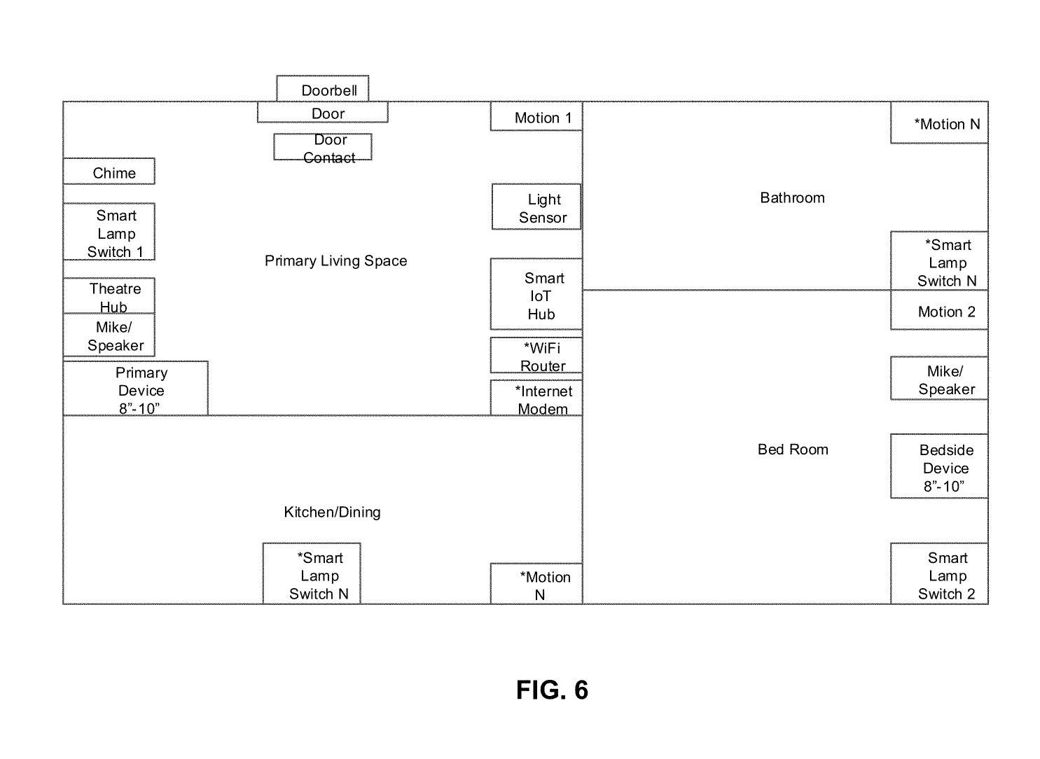

According to one embodiment, each premise has been configured and equipped with a set of devices and/or sensors that are configured to help the corresponding primary user on a daily basis using a set of preconfigured daily routines. Each of the premises 102 includes one or more devices 111 (e.g., mobile devices), a number of sensors 112, and one or more CareCircle assist buttons 113 (also referred to as a panic button) disposed at a variety of location within the premise, for example, as shown in FIG. 6. Each of devices 111 includes an application running therein that will interface and interact with the primary user, such as a mobile application running within a mobile device (e.g., mobile phones, tablets, and laptops). User devices 111 are configured specifically to the primary users' specific needs. For example, for aging users, the fonts or buttons may be configured larger than the devices used by ordinary people. The applications running within devices 111 can communicate with routine management system 101 through a variety of communication protocols.

In addition, sensors 112 can be utilized to monitor the actions of the primary user within premise 102. Some of the sensors 112 may be IoT sensors that can send signals to a remote destination such as routine management server 101. For example, some of sensors 112 may include smart IoT devices such as doorbell, thermostat, light, motion sensors, door contacts, etc. Some of sensors 112 may include vital status monitor or measurement devices for measuring blood pressure, heartrate, sugar level, etc. At least one or more of these devices or sensors 112 are communicatively coupled to routine management server 101, directly or indirectly via cloud service providers 104. CareCircle assist buttons 113 can be utilized by the primary user to initiate an event to request for help. When CareCircle assist button(s) 113 is pressed by the user, a signal will be transmitted to routine management system 101 over network 105, and a preconfigured CareCircle assist routine will be carried out.

In one embodiment, routine management server 101 includes a routine manager or routine executor 115 managing a number of routines 116 that have been specifically configured for the primary users residing in premises 102. The routines 116 may be configured by an authorized person or administrator via a configuration interface and stored in a persistent storage device. Note that routine management system 101 is a multi-tenancy system that is configured to manage a number of primary users residing in a number of different premises or facilities. Each of the primary users will have an individual account set up in routine management system 101. A user account may also store the routines configured to the corresponding primary user (e.g., individual or aging person), as well as the secondary users 103 associated with the primary user (e.g., care givers or family members of the individual or aging person).

The routines can be any kind of daily routines that are specifically tailored to a specific primary user. The goal of a routine is to help the primary user to follow or enforce a healthy habit and monitor the activities of the primary user. The activities of the primary user may be reported to the associated group of one or more secondary users represented by secondary user devices 103. The routines may include (not limited to) a morning routine, a night routine, a nutrition routine, a medication intake routine, an appointment routine, a visitor routine, and/or an assistance routine. For each primary user, there will be at least a good morning, good evening and CareCircle assist routine, to handle an on demand event triggered by CareCircle assist button 113 press by the primary user.

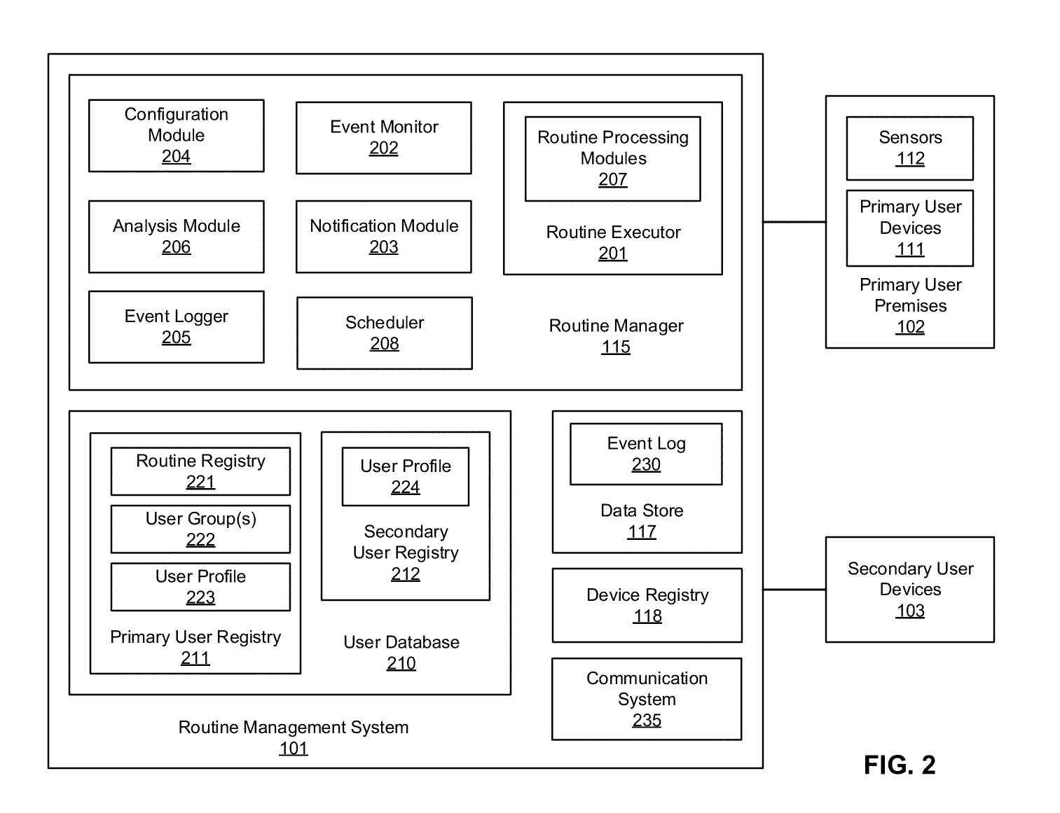

In one embodiment, for a given time of a day, routine manager 115 may determine which of routines 116 should be executed. For example, a calendar system or scheduler, such as, scheduler 208 of FIG. 2, may be utilized to schedule an execution of a routine via a configuration interface by an authorized person. The calendar system may notify or send a message to routine manager 115 in response to a scheduled routine at a particular point in time. In response, routine manager 115 is configured to launch and execute the scheduled routine or routines. Each routine may be implemented as a workflow routine that includes a number of workflow stages. Each workflow stage is associated with a workflow stage routine to be executed at a point in time associated with the workflow stage. During the execution of a routine, routine manager 115 communicates with one or more of user devices 111 to interact with the primary user, according to the specific steps or actions specified in the routine. In response to the user interaction or responses, the user responses may be logged and stored as a part of user interactive history in data store 117.

In addition, according to one embodiment, routine manager 115 is communicatively coupled to each of sensors 112 over network 105, directly or indirectly via cloud service providers 104. Routine manager 115 periodically receives sensor data or sensor signals from sensors that sense the living environment of the primary users at premises 102. Based on the sensor data, routine manager 115 can determine the status or state of the associated a primary user and determine whether the primary user needs help or the primary user has performed actions confirming the actions as expected or specified in the corresponding routines. Further, dependent upon the specific configuration, a notification of an event detected or received by routine manager 115 may be sent to one or more secondary user devices 103 of one or more secondary users associate with the primary user. An authorized user can specify or register specific secondary users to receive notifications of specific events.

With the help from a variety of sensors or IoT devices, routine manager 115 can monitor a primary user on a specific routine precisely. In one embodiment, one of the daily routine is to monitor the primary user for medication intake according to a predetermined medication intake schedule. An authorized person such as a caregiver can configure a medication intake routine via a configuration interface (e.g., a Web portal) for a particular primary user, including specific time of the day and specific medicine to take for that specific time of the day, etc. The medication intake routine can then be stored as a part of routines 116, for example, in a persistent storage device of server 101 (e.g., hard disks or cloud storage devices).

In addition, at the primary user premise, a pill dispenser device is utilized to store the medication to be taken periodically. The pill dispenser may be an IoT compliant device that includes a sensor to sense whether the pill dispenser has been accessed as an indication whether primary user has remove the medication from the pill dispenser in response to the routine reminder sent by routine manager 115 during the execution of the medication routine. When something has been removed from the pill dispenser, a signal will be transmitted to routine manager 115 over the network. Such a signal and timing of receiving the signal can be logged as a part of daily event in data store 117 for the primary user. In addition, the pill dispenser may include a number of pill slots and each slot may be equipped with a separate sensor to sense whether a pill stored in the slot has been removed. When a pill has been removed from a specific slot, a specific signal will be sent to routine manager 115 indicating which of the slots has been opened as an indication of which pill has been taken by the primary user. Routine manager 115 can then confirm against the corresponding medication intake routine to determine whether the primary user has taken the correct medication.

All of the interaction between server 101 and each primary user will be logged in an event log or event history in data store 117. The data stored in data store 117 can be analyzed subsequently, for example, by invoking machine-learning engine 120 of data analytics system 106, which may be operated by the same entity associated with server 101 or by a third party entity. Alternatively, the functionalities of data analytics system 106 may be integrated with server 101 or a backend server of server 101.

According to one embodiment, for a particular primary user, machine-learning engine 120 or an analysis module performs an analysis on the event log associated with the primary user to determine and learn the user behavior and user preference of the primary user for each of the routines and a combination of one or more of the routines associated with the primary user. Based on the analysis, some routines can be modified to be more tailored to the primary user's need. For example, if the user preference suggests that the primary user tends to wake up and get out of the bed later than the wakeup time the morning routine configured (e.g., wakeup alarm suppressed by the user or the primary user does not move based on motion sensors), wakeup time of the morning routine can be automatically adjusted accordingly. In addition, the bed time of a night routine may also be modified to ensure the primary user has sufficient sleep time.

A CareCircle assist routine is a special routine that is specifically configured for an assist, help or emergency situation. When a primary user requires assisted help immediately, the primary user can initiate the execution of the CareCircle assist routine by pressing a preconfigured CareCircle assist button. A CareCircle assist button can be a “soft” panic button that appears on an application running on any of the electronic devices such as tablet, laptop, mobile phone, wearable, etc. A CareCircle assist button can be a “hard” button of a dedicated device such as a dedicated IoT device or a dedicated pager device, where the sole or main purpose of the device is to send an on demand and immediate signal to routine manager 115 over the network.

In response to the CareCircle signal, routine manager 115 executes a CareCircle assist routine corresponding to the primary user. In one embodiment, the CareCircle assist routine identifies a group of secondary users such as secondary users 103 that have been configured to receive a CareCircle alert. A conference (e.g., audio or video conference) will then be established amongst the secondary users and the primary user automatically to allow the users to discuss the situation over the conference. In addition, according to one embodiment, if there is a need during the conference, any of the secondary users can further initiate an emergency call to an emergency medical service (EMS) facility to dispatch medical personnel to the premise (e.g., user home or assisted living facility) of the primary user, and then rejoin the conference thereafter. Alternatively, if none of the secondary users is available, for example, to join the conference, an emergency call to the EMS service may be automatically initiated. Further, the emergency call to the EMS may be automatically initiated based on the medical history of the primary user (e.g., learned by the machine-learning engine).

FIG. 2 is a block diagram illustrating an example of a routine management system according to one embodiment. Referring to FIG. 2, routine manager 115 includes, amongst others, routine executor or execution module 201, event monitor 202, notification module 203, configuration module 204, event logger 205, an analysis module or reporting module 206, and scheduler 208. Routines 201-206 and 208 may be implemented in software, hardware, or a combination thereof. Some of these modules may be integrated into fewer modules.

In addition, according to one embodiment, server 101 further maintains a database to store user information, routine information, schedule information and event information. In this embodiment, a user database 210 is maintained to store any information associated with users, either primary users or secondary users. As described above, server 101 is a multi-tenancy system that provides routine management services to a variety of clients such as user's home or assisted living facilities, primary users, and/or secondary users. Each user may have a user account configured in user database 210 to store any user related information of that user, such as, for example, one or more routines registered in routine registry 221 for a primary user, one or more user groups 222 (e.g., secondary users) associated with the primary user, and a user profile of the primary user.

In one embodiment, user database 210 further maintains a secondary user registry 212 to store any information concerning secondary users, such as user profiles 224 of the secondary users. For example, a secondary user can register or specify which primary user or primary users the secondary user is associated with, what types of events of the associated primary user(s) the secondary would like to be notified, and the user devices of the secondary user that would receive the notification, etc. Note that primary user registry 211 and secondary user registry 212 may be integrated as a single user registry.

Data store 117 may also be implemented as an event database or interactive history database to store any event logs 230 recording interactions between server 101 and other entities such as primary users at user premises 102 and secondary users 103. Alternatively, an event log of a particular user (e.g., primary user, secondary user) may be maintained as a part of a data entry of user database 210 associated with that particular user. Other configurations may exist. The data stored in data store 117 can be analyzed by analysis module 206, for example, to generate a summary report of a particular primary user representing the activities over a period of time in response to a query from a secondary user (e.g., care giver or family member) via a Web portal interface.

According to one embodiment, routine executor 201 is configured to execute one or more routines for a number of primary users residing at variety of facilities, where the routines have been configured for the primary users and stored in a user account of each primary user. Routine executor 201 may include one or more specific routine processing modules 207 configured to process a specific type of routines, such as CareCircle routines, morning routines, medication intake routines, etc. The routines may also be scheduled by scheduler 208 in a calendar system for a specific time of a day, which may in turn notify routine executor 201 to execute an associated routine at the scheduled time and date. For example, an authorized person may access scheduler 208 via configuration module 204 to schedule one or more routines to be executed at particular points in time. Note that server 101 may provide routine management services for a large number of primary users of a large number of premises. Server 101 may be one of a number of server instances hosted in the cloud. The functionalities of server 101 may be hosted in a number of cloud servers such as in a software-as-a-service (SaaS) manner hosted in a platform-as-a-service (PaaS) configuration.

Referring back to FIG. 2, for each of the routines executed, the corresponding routine processing modules 207 are configured to communicate and interact with user devices of primary users such as applications running at user devices 111 of the primary users, as well as secondary user devices 103 of the associated secondary users, according to the executed routines. Event monitor 202 is configured to monitor and receive any event from a variety of sensor devices 112 such as IoT devices over a network. Sensor devices 112 may include motion sensors, CareCircle buttons, lights/lamps, pill dispensers, doorbells, etc. For some of the events, notification module 203 is configured to send notifications to the associated secondary users 103, dependent upon the specific configurations at associated primary user registry 211 and secondary user registry 212. For example, notification module 203 may invoke communication system 235 to communicate with the users. Communication system 235 is capable of handling a variety of types of communications such as SMS, emails, audio or video conferences, etc. Communication system 235 may be implemented as an external third-party communication system. Routine executor 201 works with event monitor 202 and notification module 203 to determine the user interaction of the primary users and the conditions of their premises. Based on the events received from event monitor 202, routine executor 201 may perform different actions according to the associated routines.

In one embodiment, event logger 205 is configured to record any events received from event monitor 202 and any or selected activities performed by routine executor 201 and/or notification module 203. The logged information can be stored in the corresponding event logs 230 and stored in data store 117. The logged data may include the types of events or actions, as well as timestamps of the events or actions. The event logs 230 may be analyzed by analysis module 205 subsequently, either online or offline. Alternatively, event logs 230 may be analyzed by a machine-learning engine hosted by a separate server or a third-party entity.

In one embodiment, device registry 118 is configured to store any devices or sensors registered for the primary users. In response to an event or signal received by event monitor 202, device registry 118 is utilized to determine which of the devices and where the device is located, as well as the corresponding primary users.

In one embodiment, configuration module 204 allows an authorized user, for example, via a configuration interface (e.g., Web portal, a mobile application programming interface or API) to configure or provision routines and stored in routine registry 221 for a primary user and user profile 223 of the primary user. Configuration module 204 further allows an authorized user to configure one or more secondary users 222 related to a primary user, as well as user profiles 224 of the secondary users. Configuration module 204 further allows an authorized user to schedule a routine to be executed at certain point in time by invoking scheduler 208. The scheduled event will be stored as a part of calendar event of a calendar system associated with scheduler 208. Each event is associated with a routine to be executed at the time of the event.

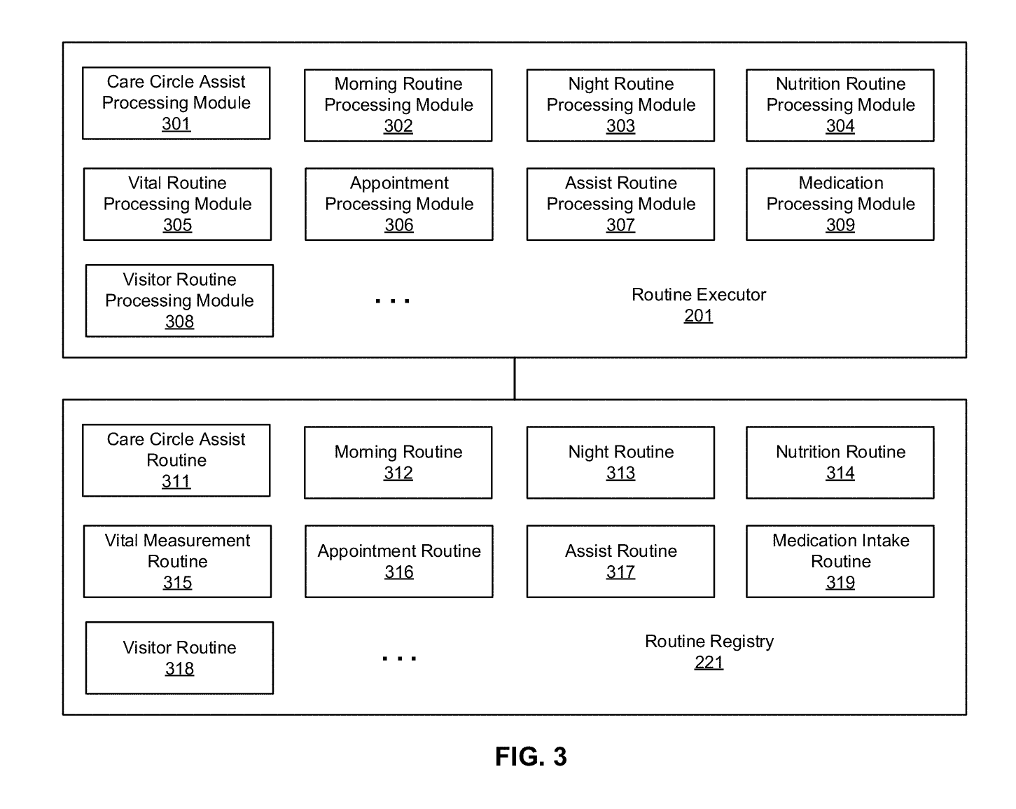

FIG. 3 is a block diagram illustrating an example of a routine management system according to another embodiment of the invention. Referring to FIG. 3, routine executor 201 includes a variety of routine processing modules 207 for a variety of purposes. In this example, routine executor 201 includes CareCircle assist routine processing module 301, morning routine processing module 302, night routine processing module 303, nutrition routine processing module 304, vital routine processing module 305, appointment routine processing module 306, assist routine processing module 307, visitor routine processing module 308, or medication routine processing module 309. Note that dependent upon the specific configuration, some of these routine processing modules may be integrated into a fewer number of modules. More routine processing modules may also be included to handle additional types of routines.

Routine registry 221 includes a variety of routines that can be configured and provisioned by an authorized user via configuration module 204 and scheduler 208. Note that routine registry 221 may be configured on a per primary user basis. That is, each primary user may be associated with a set of routines configured specifically for the corresponding primary user. In one embodiment, dependent upon the specific configuration of a primary user, routine registry 221 of a primary user can include one or more of CareCircle assist routine 311, morning routine processing module 312, night routine processing module 313, nutrition routine 314, vital routine 315, appointment routine 316, assist routine 317, visitor routine 318, or medication intake routine 319. Routines 311-319 may be configured via a configuration interface using configuration module 204, which may be configured in a form of scripting languages such as extensible markup language, XML or other. Details of these routines will be described further below. Different primary users may have different numbers of routines provisioned. Each type of routines associated with different primary users may also be different. At runtime, dependent upon the specific configuration of a specific primary user, some or all of routines 311-319 may be executed with the corresponding routine processing modules 301-309 respectively.

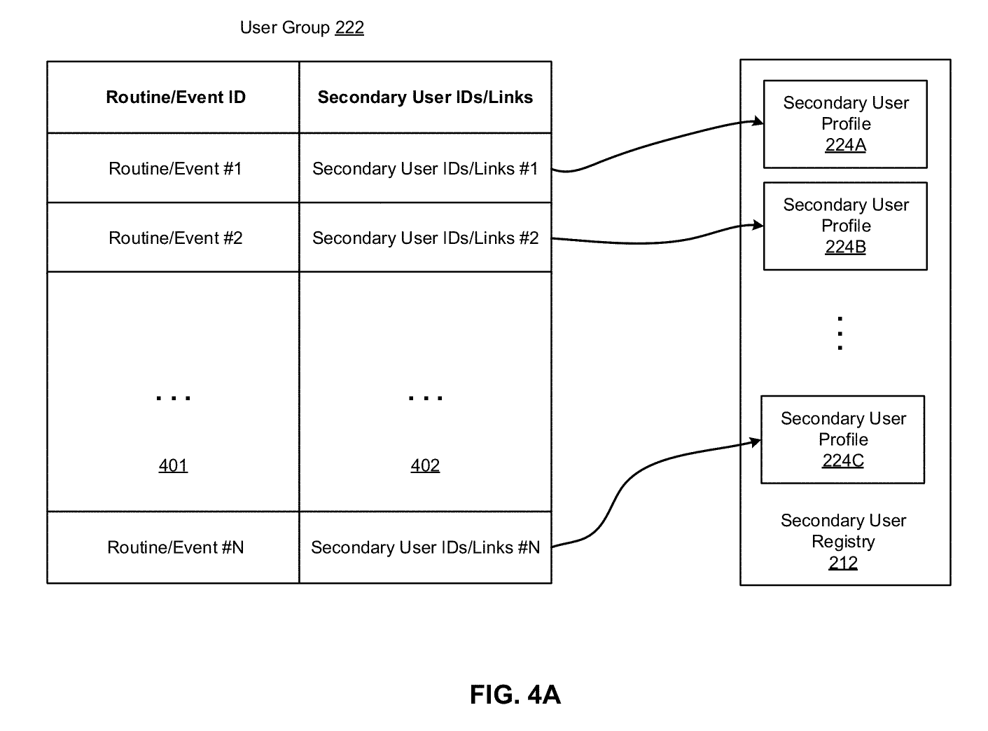

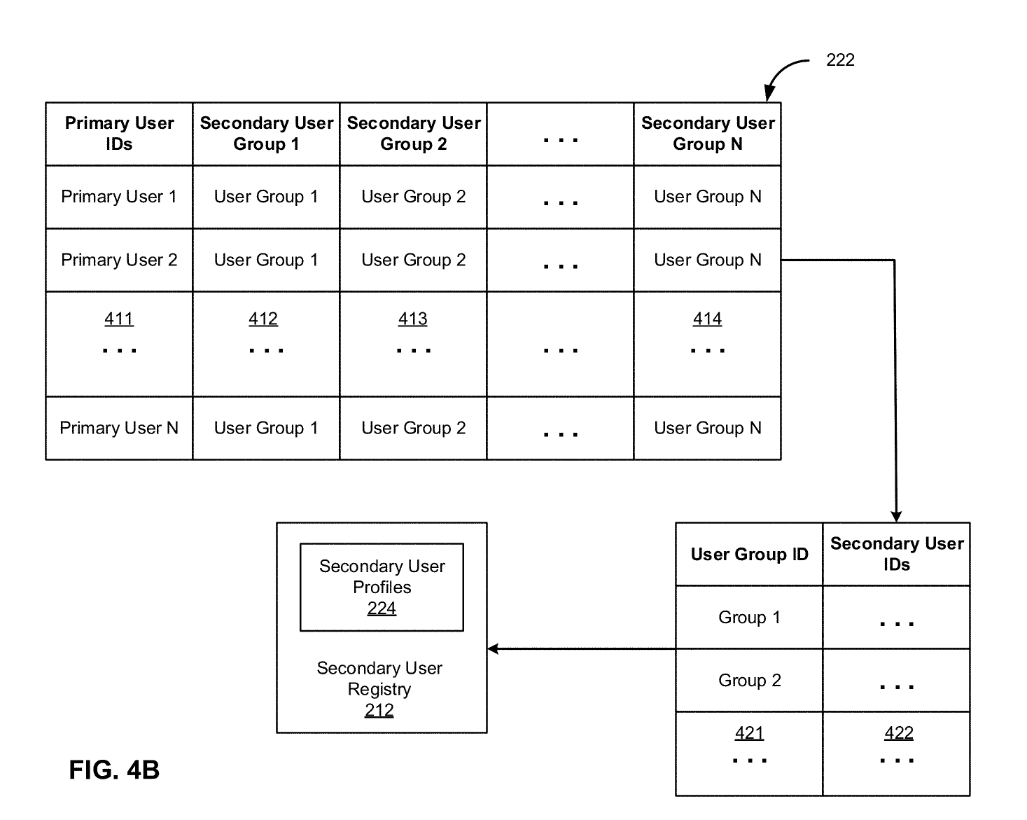

FIGS. 4A and 4B are block diagrams illustrating examples of user registries according to certain embodiments of the invention. Referring to FIG. 4A, primary user registry 211 includes a number of data structures to store secondary user group information for primary users. In this example, each of the registered primary users is associated with a user group data structure, such as a table, i.e., a per user table. In one embodiment, a user group table 222 for each primary user includes a number of mapping entries. Each mapping entry is to map a particular routine or a particular event 401 to a set of user identifiers (IDs) 402 that identify a group of one or more secondary users. The secondary users are referred to as members of a caregiver group or a CareCircle (i.e., CareCircle members).

A secondary user ID can be anything that can uniquely identify a particular user, which can be an email address, a phone number, a chat ID, etc., or a combination thereof. Each of the secondary IDs 402 can be utilized to access a user profile of a corresponding secondary user (e.g., user profiles 224A-224C, collectively referred to as user profiles 224) stored in secondary user registry 212. In one embodiment, the user group table 222 of primary user registry 211 and secondary user registry 212 can be utilized to obtain a set of one or more secondary users for the notification purposes in response to certain events of certain routines or a CareCircle assist conference in response to a CareCircle signal.

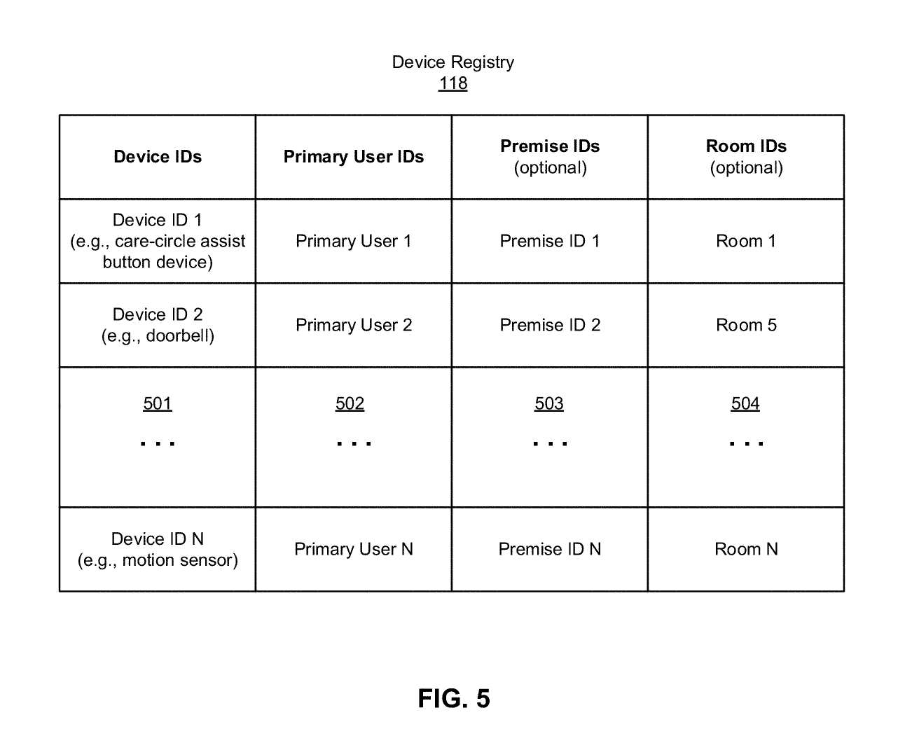

For example, in response to a CareCircle assist signal received from a CareCircle button device of a primary user, a CareCircle assist routine executed by the CareCircle assist routine processing module 301 identifies a primary user ID of the primary user based on the CareCircle assist signal. In one embodiment, a CareCircle device ID can be determined based on the CareCircle assist signal. Based on the CareCircle device ID, a primary user ID of the primary user can be ascertained, for example, by looking up in device registry 118 as shown in FIG. 5.

Referring now to FIG. 5, device registry 118 stores all of the device information of devices disposed at various locations within the primary premises of the supported primary users. In one embodiment, device registry 118 includes a number of entries. Each entry maps a particular device ID 501 of a particular device to a primary user ID 502 of a primary user. In addition, each entry optionally maps a device ID 501 to a premise ID 503 of a primary user premise and/or a room ID 504 of a room of the primary premise in which the device is located. Note that a primary user premise may include a variety of sensors or devices, as shown in FIG. 6, which collectively monitor, guide, and help the primary users on their daily activities. In response to a signal received from a particular device or sensor, a primary user and the primary user premise can be identified, and appropriate actions can be initiated.

Referring back to FIG. 4A, based on the primary user ID, user group table 222 associated with the primary user can be retrieved from a database entry of a user database corresponding to the primary user. A lookup is performed on user group 222 based on a routine ID identifying the CareCircle assist routine to locate an entry having routine ID 401 matching the CareCircle routine ID. From the matching entry, a set of secondary user IDs can be obtained from field 402. Based on the secondary user IDs, the user profiles of the corresponding secondary users can be obtained from secondary user registry 212. A video conference or an audio conference can be established amongst the secondary users and the primary user. Similarly, for a particular routine listed in field 401, the same set of a different set of secondary users may be specified in field 402. In response to certain events of the routine, the specified secondary users can be notified.

Note that in this example, the CareCircle members are configured for specific routines. Alternatively, the CareCircle members can also be configured for specific types of events. Each routine may include or trigger certain types of events and some of the events may be common to some routines. A routine may trigger or launch another routine in response to a preconfigured condition that has been satisfied during the initial routine. By mapping different groups of secondary users to different type of events, certain secondary users having certain special expertise can provide care services for similar events of different routines. Similarly, some secondary users can also provide care services for different primary users, for example, by mapping the corresponding secondary user IDs to different routines or events of different primary users.

As shown in FIG. 4A, a separate database or table for mapping secondary users is maintained for each primary user. Thus, there will be a number of mapping tables for a number of primary users. Alternatively, a global or single table may be maintained as shown in FIG. 4B. Referring to FIG. 4B, user group table 222 includes a number of entries. Each entry maps a particular primary user ID 411 to a set of one or more secondary user groups 412-414 for different types of routines or different types of events. Each secondary user group may be associated with one or more secondary user IDs, which can be identified by looking up in secondary user registry 212. In this example, the secondary user registry 212 maps each of the secondary user group IDs 321 to a set of one or more secondary user IDs 422. The secondary user IDs 422 can be utilized to access the user profiles of the corresponding secondary users. A user profile of a user may include information specifying certain user preferences such as the specific communication protocols or user devices for subscribing certain types of events or certain types of routines, etc.

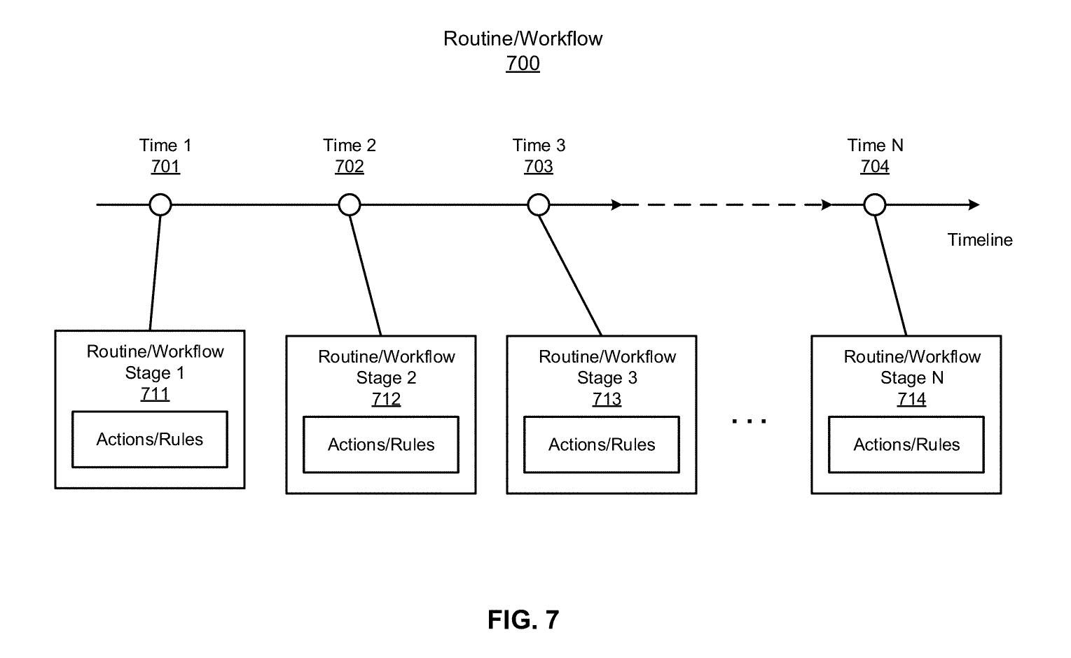

FIG. 7 is a diagram illustrating an example of a routine according to one embodiment. Routine 700 may represent any of the routines as described above such as routines 116 of FIG. 1. Referring to FIG. 7, in this example, routine 700 is implemented as a workflow having a number of workflow or routine stages corresponding to different points in time 701-704. Each of the workflow stages is associated with a set of one or more actions (e.g., actions 711-714, also referred to as subroutines) that will be performed or carried out at the corresponding point in time. An action can be simply sending a greeting message at the beginning of a morning routine or a reminder to sleep during a night routine. An action can also be a sequence of interactions or dialogs between the routine and the primary user. An action can also be another routine to be launched and executed, which has been configured to perform a specific action. Each workflow stage may further include a state machine that is utilized to control the transaction amongst the states dependent upon the response received from the primary user as a part of conversation between the routine and the primary user.

When routine 700 is loaded into a memory and executed by a processor, i.e., a corresponding routine processing module, the routine processing module periodically examines the conditions associated with the routine. When a condition of a workflow stage has been satisfied, one or more actions that have been configured for the workflow stage will be performed and carried out. For example, when the time of the day reaches point in time 702, the actions 712 configured for the workflow stage 702 will be performed. The actions may be configured and specified in XML. When time 703 comes, action(s) 713 will be performed, and the user interactions and any events occurred during the interactions will be recorded as a part of interaction history stored in the corresponding event log associated with the primary user. The event log can be analyzed subsequently, either dynamically or offline and some of the routines or timing and actions of a routine may be automatically modified based on the analysis.

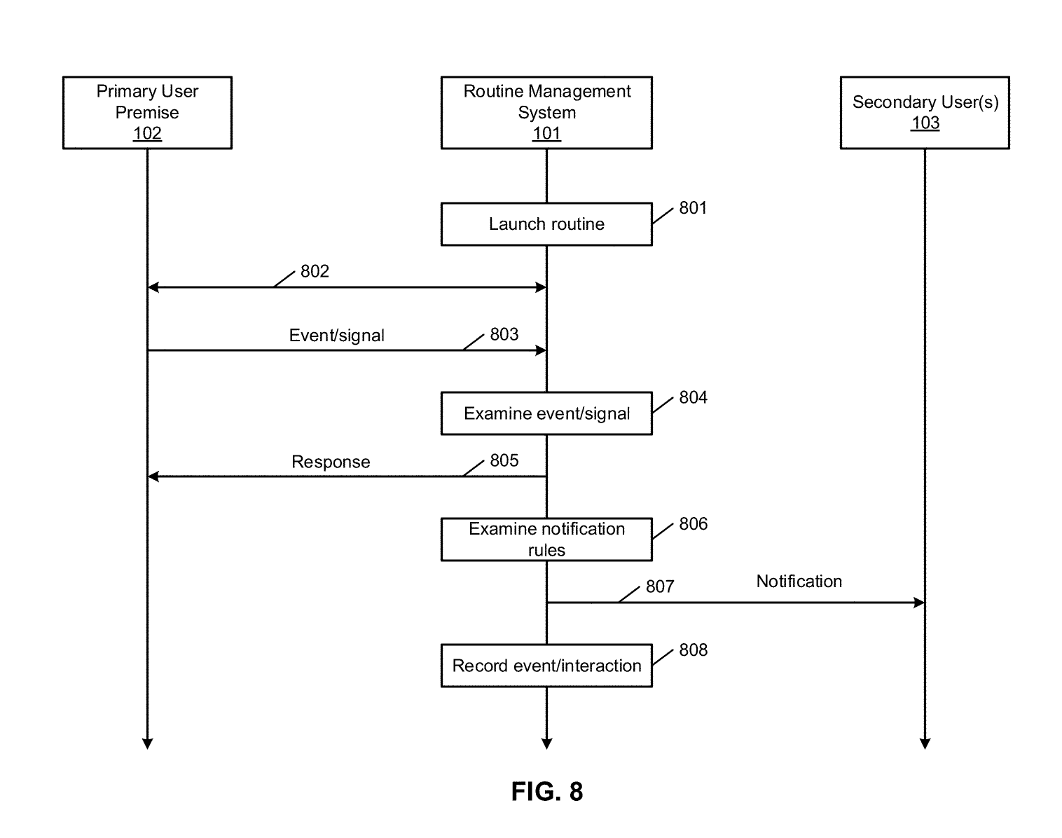

FIG. 8 is a process flow diagram illustrating an example of interactions amongst parties of routine management according to one embodiment. Referring to FIG. 8, at block 801, a preconfigured routine is loaded and executed by a corresponding routine processing module of routine executor 201 of routine management system 101. The routine processing module exchanges messages, via path 802, with one or more user devices of a corresponding primary user of primary user premise 102. For example, for a morning routine, the routine processing module may send a greeting message to a primary user device and the primary user may respond. Based on the response from the primary user, the routine processing module may further respond according to the routine settings.

Subsequently, when an event occurs or a signal is received via path 803, for example, from certain sensors or IoT devices from primary user premise 102, the routine processing module examines a set of rules at block 804 and responds accordingly according to the rules via path 805. The rules for responses may have been configured as routine metadata as a part of the routine. In addition, at block 806, the routine processing module examines a set of notification rules or settings associated with the routine, such as for example, user group settings as shown in FIG. 4A. The routine processing module determines a group of one or more secondary users associated with the primary user, for example, by looking up in the primary user registry and the secondary user registry as described above. If there is a need to notify a secondary user according to the notification rules, a notification message will then be transmitted via path 807 to one or more of secondary users 103. At block 808, the above interactions and events are recorded and stored in a corresponding event log for subsequent analysis. Certain settings of the routine, such as timing of the events, may be modified based on the analysis.

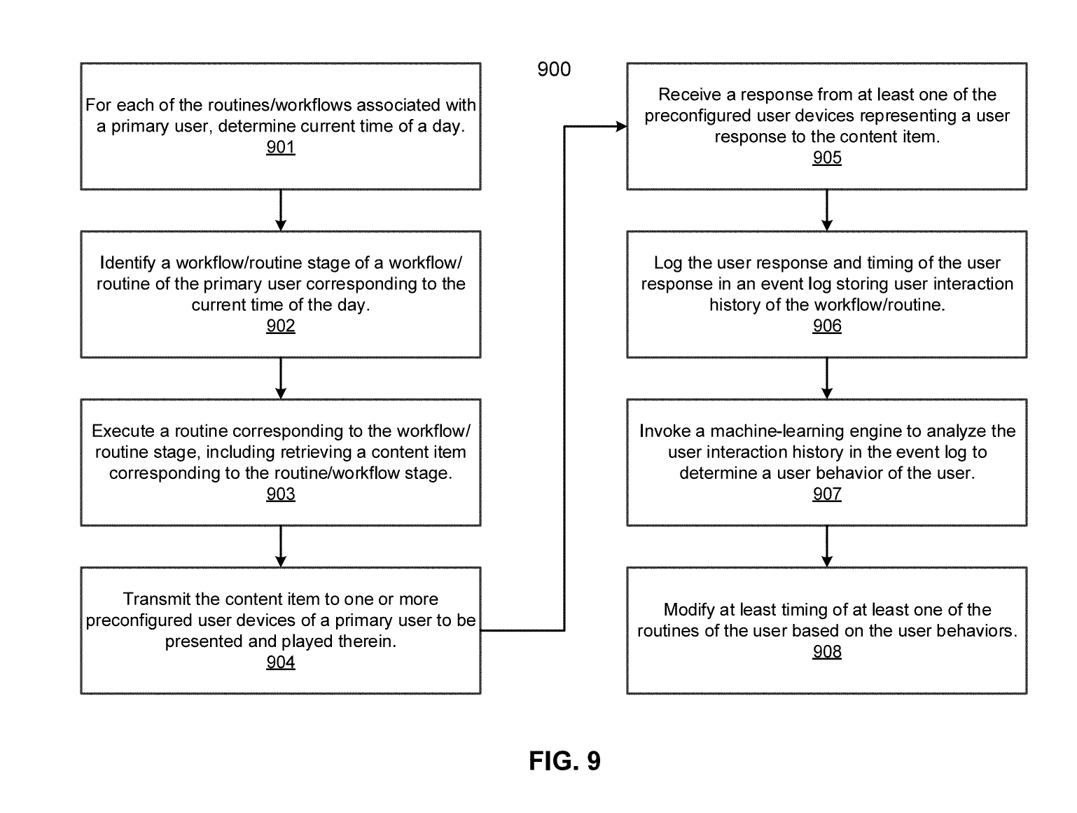

FIG. 9 is a flow diagram illustrating a process of execution of a routine according to one embodiment. Process 900 may be performed by processing logic which may include software, hardware, or a combination thereof. For example, process 900 may be performed by routine management system 101. Referring to FIG. 9, at block 901, for each of the routines associated with a primary user, processing logic determines current time of a day. At block 902, processing logic identifies a workflow stage of a workflow corresponding to a preconfigured routine, where the workflow stage corresponds to the time of the day. At block 903, processing logic executes a subroutine associated with the workflow stage including retrieving a content item corresponding to the workflow stage. At block 904, processing logic transmits the content item to one or more preconfigured user devices of the user (e.g., primary user) to be presented and played on the user devices. The content item can be a message, an image, text for display or spoken via TTS (Text to Speech), an audio or sound file, an audio stream, or a video stream, etc.

In one embodiment, the content item can simply be a greeting message or a wakeup alarm of a morning routine, or a reminder it's time to sleep via the night routine. It can be a message to follow up in response to a signal received from a sensor or an IoT device of the primary user. For example, in response to determining that the primary user has not moved for a period of time based on one or more motion sensors, processing logic sends a message to the primary user device to remind the primary user to move around. The processing logic may repeatedly send a reminder if the routine does not detect any further movement based on the motion. In one embodiment, if there is no movement after several reminder messages have been sent, processing logic may initiate a notification to CareGiver or initiate the CareCircle event, for example, by notifying the corresponding secondary users and/or contacting an EMS service provider to send someone to inspect the premise of the primary user.

In another embodiment, the content item can be a reminder of an appointment or a visitor of the primary user. For example, in response to a signal received from a smart doorbell, the routine may examine calendar data of the primary user to identify an appointment between the primary user and the visitor. The routine then sends a reminder to the primary user reminding the primary user of the appointment, including providing identity of the visitor to the primary user. In addition, the routine may verify the visitor by comparing an image of the visitor captured by a camera of the doorbell to the primary user with a previously stored image of the visitor. The image of the visitor may also be transmitted to the primary user.

Similarly, based on the calendar data associated with the primary user, the system can determine that there is an appointment that has been scheduled for a specific point in time of the day. The routine may send a reminder to the primary user to remind the primary user an upcoming appointment. The routine may further offer to help in arranging the transportation for the primary user to travel to the destination of the appointment.

According to another embodiment, the content item can be a reminder to remind the primary user to take medication at a configured time of the day according to a preconfigured medication intake routine. The medication intake routine works with a smart pill dispenser to monitor whether the primary user has opened the pill dispenser and which pill has been removed from the pill dispenser, to determine whether the primary user has taken proper medication.

Referring back to FIG. 9, at block 905, processing logic receives a response from at least one of the user devices of the primary user representing a user response in response to the content item. At block 906, the user response and timing of the user response are recorded in an event log storing the user interactions history of the routine. At block 907, processing logic invokes a machine-learning engine to analyze the user interaction history in the event log to determine user behaviors and user preference of the user. At block 908, processing logic may automatically modify timing of at least one of the routines based on the user behaviors and user preferences. For example, the timing of sending a reminder or wakeup alarm may be adjusted based on the user behaviors in the past. The operations of blocks 907-908 may be performed offline.

The above process can be applied to a variety of routines, such as, for example, a morning routine, a night routine, a nutrition routine, a vital measurement routine, an appointment routine, a visitor reminder routine, or an assist routine. One of the routines is a CareCircle assist routine that is a special routine for handling CareCircle requests from the primary users. For example, a CareCircle assist routine can be initiated to a signal received from a CareCircle button device at the premise of a primary user. When the primary user needs assistance, the primary user may press the CareCircle button of a dedicated CareCircle assist device or a CareCircle assist button of a mobile application running at a mobile device of the primary user.

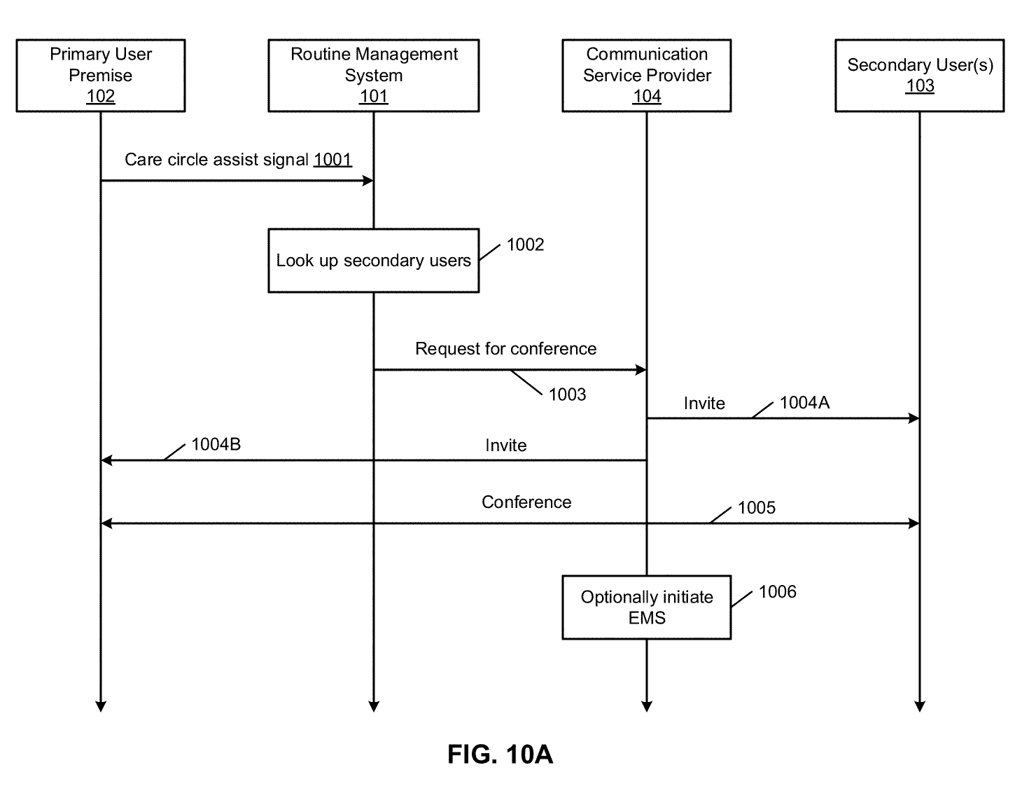

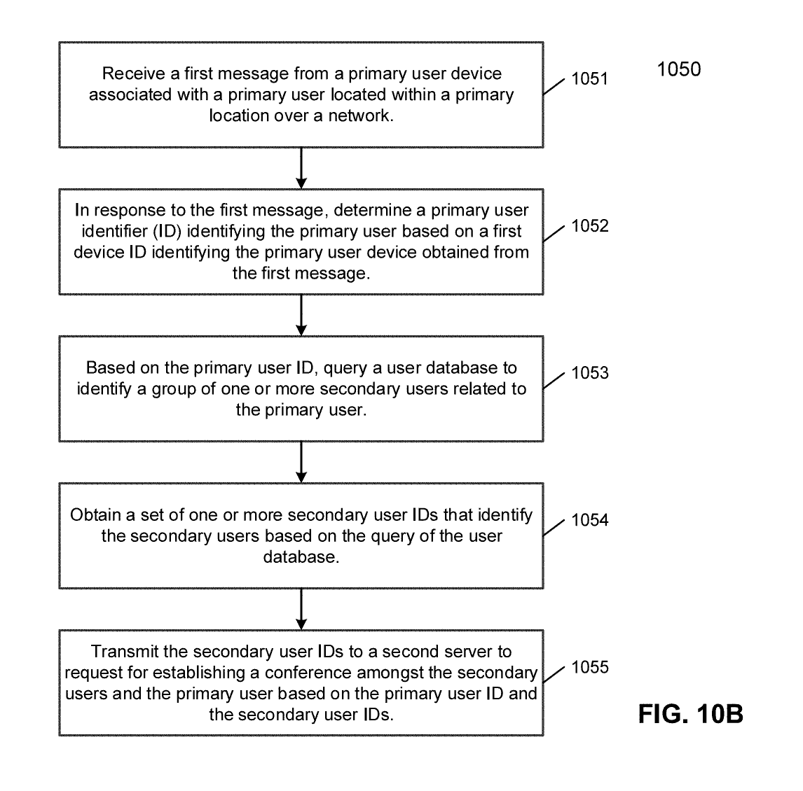

FIG. 10A is a process flow diagram for handling a CareCircle assist routine for a primary user according to one embodiment. Referring to FIG. 10A, when a primary user of premise 102 presses a CareCircle button, a CareCircle assist signal is transmitted via path 1001 to routine management system 101. In response to the CareCircle assist signal, at block 1002, a CareCircle assist routine processing module (e.g., CareCircle routine processing module 301 of FIG. 3) executes a corresponding CareCircle assist routine (e.g., panic routine 311). The CareCircle assist routine in turn looks up a primary registry of the primary user to determine a group of secondary users that are configured to be notified for the CareCircle assist situation. For example, the CareCircle assist routine accesses user group database 222 as shown in FIGS. 4A and 4B to determine the CareCircle members for the primary user.

On path 1003, the CareCircle assist routine transmits a request to a communication cloud service provider 104 to request a conference to be established. The request may include the contact information of the secondary users associated with the primary user and the contact information of the primary user. The contact information may include a phone number, a computer address (e.g., IP address), and/or a chat ID, etc. Such contact information may be stored in the secondary user registry 212 and configured to be notified specifically for the panic situation. Based on the contact information of the primary user and the secondary users, the communication service provider 104 establishes a conference amongst the primary user and the secondary users via paths 1004A-1004B. In one embodiment, in addition to the primary user, for each of the secondary users in the list received via path 1003, communication service provider 104 sends an invite to the secondary user to invite the secondary user to join the conference. Each secondary user can simply press a button or speak to join the conference.

In one embodiment, if none of the registered secondary users accepts the invitation, communication service provider 104 may automatically initiate an emergency request to a predetermined EMS service provider to dispatch EMS personnel to the premise 102. At block 1005, the conference, either an audio or video conference, is conducted. During the conference, any of the secondary users can temporarily leave the conference, initiate an emergency call to an EMS service provider, and then rejoin the conference after an EMS service has been dispatched to the primary user's premise.

FIG. 10B is a flow diagram illustrating an example of a process for handling an emergency event according to one embodiment. Process 1050 may be performed by processing logic which may include software, hardware, or a combination thereof. For example, process 1050 may be performed by routine management system 101. Referring to FIG. 10B, at block 1051, processing logic receives a first message from a primary device associated with a primary user located within a primary location or premise over a network. In response to the first message, at block 1052, processing logic determines a primary user ID that identifies the primary user based on a first device ID extracted from the first message, where the first device ID identifies the primary device.

At block 1053, processing logic queries a user database based on the first device ID, where the user database is maintained by a routine management server that provides routine management services to a variety of primary users at variety of locations. At block 1054, processing logic obtains a set of one or more secondary user IDs that identify the secondary users stored in the user database. At block 1055, processing logic transmits the secondary user IDs to a second server over the network to request the second server to establish a conference over the network amongst the secondary users and/or the primary user based on the secondary user IDs, such that the secondary users and the primary user can discuss the CareCircle assist situation.

Note that the above processes as shown in FIGS. 10A and 10B invoke a third-party or external communication system to notify the secondary users and establish a conference amongst the primary user and the secondary users. According to another embodiment, the routine management system includes a communication system built-in, such as communication system 208, which can be utilized to notify the secondary users and establish a conference event.

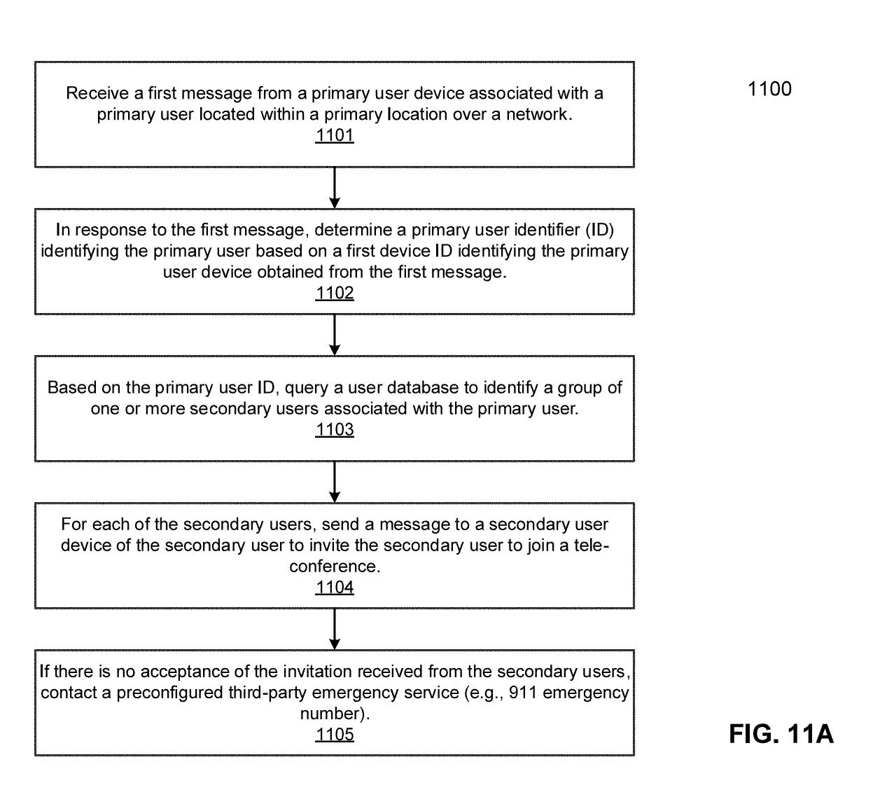

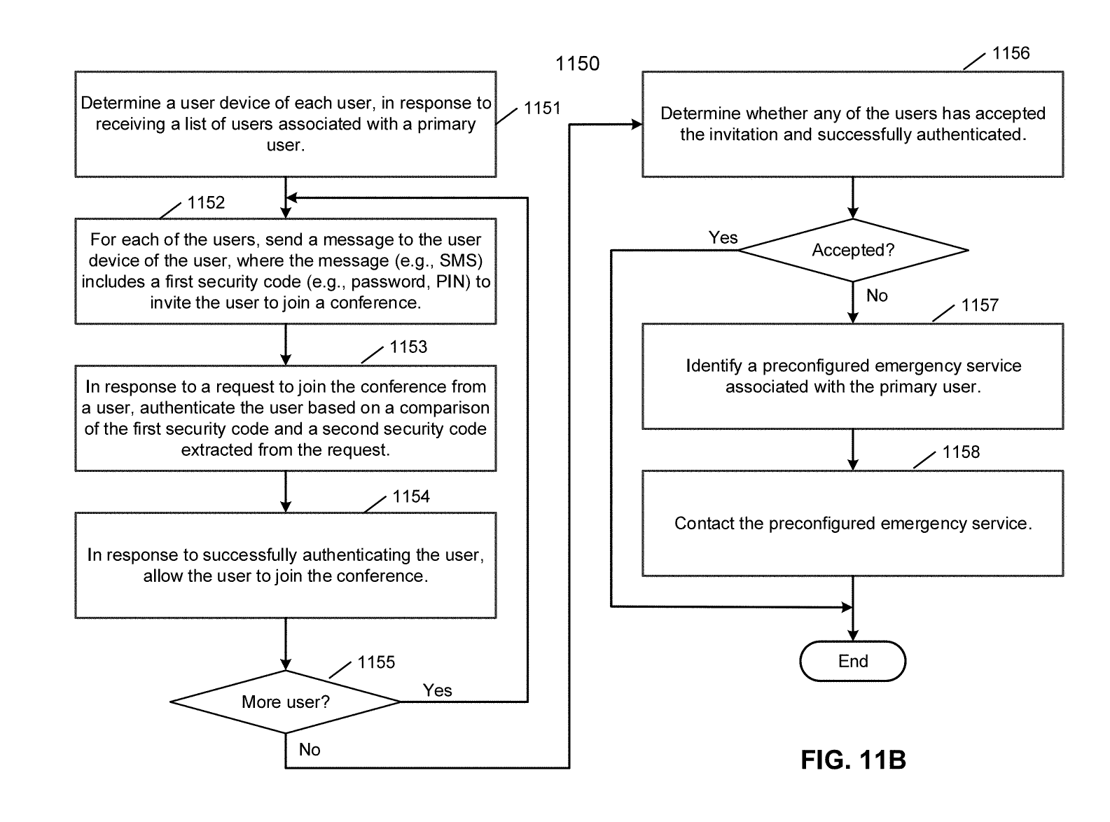

FIG. 11A is a flow diagram illustrating an example of a process for handling an emergency event according to another embodiment. Process 1100 may be performed by processing logic which may include software, hardware, or a combination thereof. For example, process 1100 may be performed by routine management system 101. Referring to FIG. 11A, at block 1101, processing logic receives a first message from a primary user device associated with a primary user (e.g., individual or senior) located within a primary location or primary residency over a network. In response to the first message, at block 1102, processing logic determines a primary user ID that identifies the primary user based on a first device ID identifying the primary user device, which is obtained from the first message. Based on the primary user ID, at block 1103, processing logic queries a user database to identify a group of one or more secondary users (e.g., care circle members) associated with the primary user. At block 1104, for each of the secondary users, processing logic sends a message to a secondary user device of the secondary user to invite the secondary user to join a tele-conference. If none of the secondary users has accepted the invitation to join the conference, at block 1105, processing logic contacts a preconfigured third-party emergency service (e.g., EMS emergency service provider), such that the primary user's request will be answered.

FIG. 11B is a flow diagram illustrating an example of a process for notifying secondary users according to one embodiment. Process 1150 may be performed as a part of operations involved in blocks 1104-1105. Alternatively, process 1150 may be performed by a third-party communication service provider such as communication service provider 104. In response to a list of users associated with a primary user, at block 1151, processing logic determines a user device of each of the users. At block 1152, for each of the users, processing logic sends a message (e.g., an SMS message) to the user device of the user. The message may include a first security code (e.g., password, personal identification number or PIN) to invite the user to join a conference. The message may further include a name of the user, a time of the conference, and a callback number or link for the user to join the conference.

In response to a request to join the conference, at block 1153, processing logic authenticates the user based on a comparison of the number they are calling from. If the number is contained on a white list as a known user they are admitted to the teleconference without prompting for a security code, if they are not, they must enter the first security code and a second security code extracted from the request. At block 1154, in response to a successful identification or successfully authenticating the user, processing logic allows the user to join the conference. The processing logic may announce the name of the user joining the conference. If there are more users in the list, the above operations in blocks 1152-1154 are repeatedly performed. If all of the users in the list have been processed, at block 1156, processing logic determines whether any of the users in the list has accepted the invitation and successfully authenticated. If at least one of the users joins the conference successfully, the process ends. If none of the users has successfully joined the conference, at block 1157, processing logic identifies a preconfigured emergency service associated with the primary user. The preconfigured emergency service may be by default a government emergency dispatcher (e.g., 911 services) or a third party emergency service provider that provides around the clock services. At block 1158, the processing logic contacts the identified emergency service.

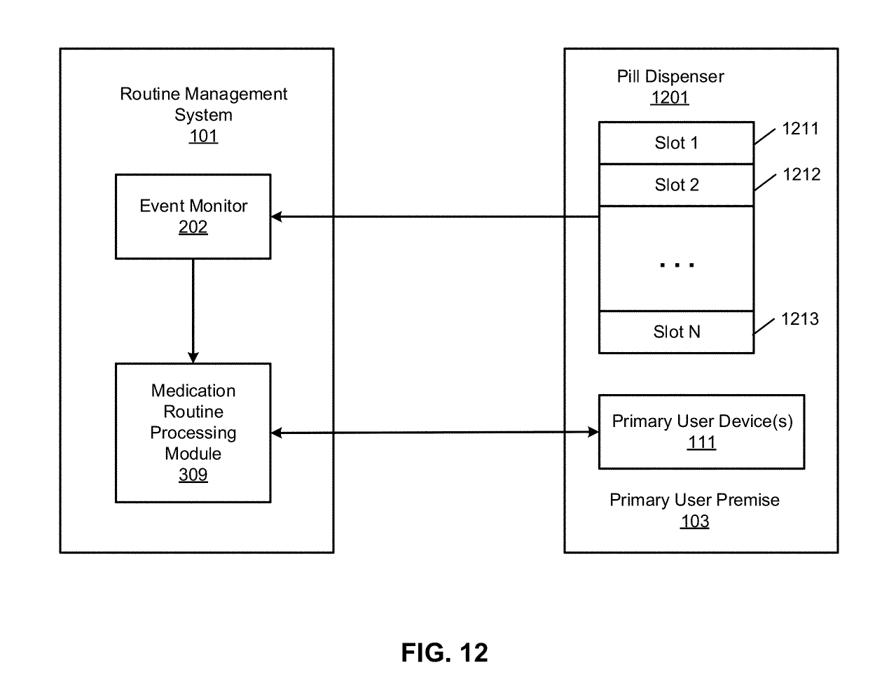

FIG. 12 is a block diagram illustrating an example of a medication routine service according to one embodiment of the invention. Referring to FIG. 12, a pill dispenser 1201 may be utilized to store the medication of a primary user. The pill dispenser 1201 may be a smart IoT device that can detect whether a cover or lid of the pill dispenser has been opened as an indication of the medication intake and send a signal to routine management system 101 over a network for such detection. For example, there may be pressure sensor disposed within pill dispenser 1201 to detect opening of the cover.

When a medication routine such as medication intake routine 319 is executed by medication routine processing module 309, the medication intake routine communicates with primary user device 111 over a network. Medication intake routine 319 can be configured to send a reminder at different points in time during the day to remind the primary user to take certain medication. When the time to take particular medication comes, processing module 309 sends a reminder message to primary user device 111 to remind the primary user it is time to take specific medication. The reminder message may include information of the specific medication that the primary user needs to take. The reminder message may further include the name and/or an image of the medication or medicine.

Once a reminder message has been sent, the processing module 309 monitors the responses from the primary user. The primary user may respond through its primary user device 111 by returning a message that the primary user has taken or will take the medication as a confirmation. If the primary user does not respond or confirm for a predetermined period of time, another reminder may be periodically sent. If after a number of reminder messages have been sent and no response or confirmation has been received, a notification may be sent to one or more of the secondary users associated with the primary user indicating that the primary user has not followed the medication routine properly. Alternatively, a CareCircle event may be triggered to enable someone locally or from an EMS service provider to visit the primary user.

In one embodiment, event monitor 202 may also be utilized to monitor whether the primary user has followed the instructions or reminders received from medication routine processing module 309 by monitoring operations of pill dispenser 1201.

In one embodiment, in response to a medication intake reminder, the primary user may open and take the instructed medication from pill dispenser 1201. As a result, a signal is transmitted from pill dispenser 1201 and received by event monitor 202 over a network. For example, a pressure sensor (not shown) disposed within pill dispenser 1201 can detect that a cover or door has been opened by the primary user and pill dispenser 1201 sends a signal to event monitor 202 in response to the detection of the pressure sensor. The signal can be utilized as a confirmation that the primary user has followed the instructions or reminders. Note that the signal may be routed to a pill dispenser provider in the cloud before being routed to the routine management system 101.

According to another embodiment, pill dispenser 1201 may include a number of pill slots 1211-1213. Each of pill slots 1211-1213 may store medication for a particular time of a day, a particular day of a week, or a particular week of a month, etc. Each of pill slots 1211-1213 may be associated with a sensor such as a pressure sensor to sense and detect whether a particular medicine pill has been removed from the corresponding pill slot. If something has been removed from a pill slot, a signal will be send to event monitor 202, where the signal includes information identifying the corresponding pill slot. As a result, when the primary user removes a pill from a particular slot, medication routine processing module 309 can determine whether the primary user has taken proper medication as instructed for the particular time or routine stage. If the signal indicates that the medication has been removed from an unexpected pill slot, there may be a chance that the primary user has removed the wrong medication. Processing module 309 may send a query to primary user device 111 to ask the primary user to confirm. In the event that the primary user has taken a correct medication, a notification may be transmitted to a secondary user or a CareCircle assist event may be triggered, dependent upon the specific notification configuration for the medication intake routine 309.

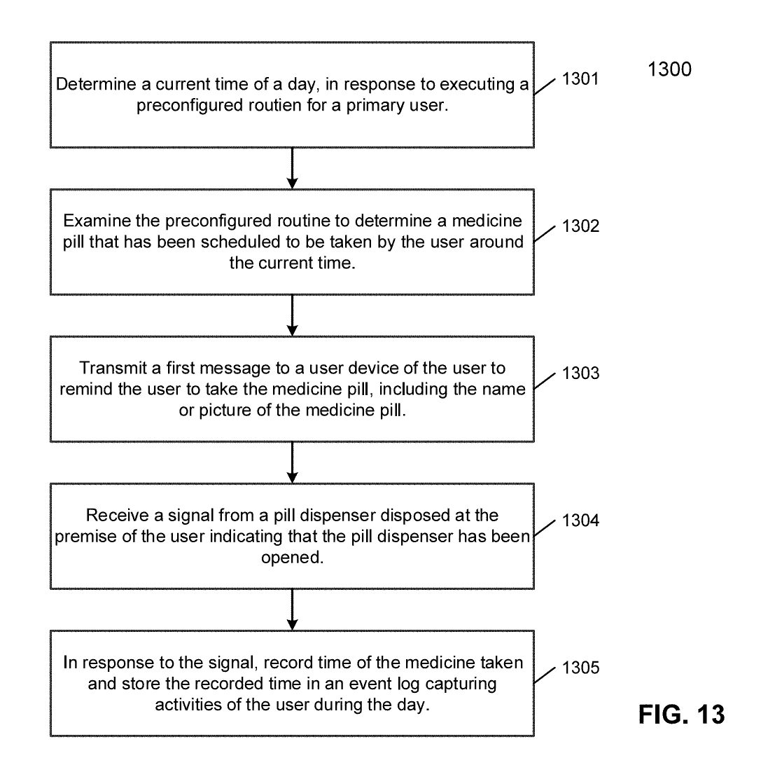

FIG. 13 is a flow diagram illustrating an example of a process of enforcing a routine associated with a user according to one embodiment. Process 1300 may be performed by processing logic which may include software, hardware, or a combination thereof. For example, process 1300 may be performed by routine management system 101. Referring to FIG. 13, in response to executing a preconfigured routine, at block 1301, processing logic determines a current time of a day. The preconfigured routine includes a number of actions (e.g., medication intake reminders) to be performed at different points in time of the day. At block 1302, processing logic examines the preconfigured routine to determine a medication pill that has been scheduled to be taken by a primary user around the current time of the day. At block 1303, processing logic transmits a first message to a primary user device of the primary user to remind the primary user to take the scheduled medication. The first message includes information identifying the scheduled medication such as the name or image of the medication. At block 1304, processing logic receives a signal from a pill dispenser disposed within the primary premise of the primary user indicating that a cover or door of the pill dispenser has been opened. In response to the signal, at block 1305, the timing of receiving the signal is recorded and stored in the event log associated with the primary user.

According to certain embodiments, the routine management system as described above is also referred to as a Routinify™ system designed to enable unmanned and unattended coaching, prompts and cues to develop habits in ageing individuals at home, as well as the ability of a CareCircle member to view and manage all data and activity of individuals.

The system utilizes IoT and medical devices on an individual's premise to aid in collecting information about the individual's habits, movement and health state. The IoT devices can be any of, but not limited too; motion sensor, open/close contacts, smart thermostat, smart light bulb, smart power switch, smart power/light dimmer, home audio and video control, programmable button for CareCircle, blood pressure, oximeter, scale, glucose, other IoT and/or medical devices. The system utilizes one or more local computing devices as the means to communicate via; sound, voice, visual coaching, prompts and cues to an individual in their premise. Local computing devices at the premise collect audible and touch input as needed from an individual. Local computing devices communicate all information to a cloud system where all information is stored, analyzed and reported from. The system is to be configured by a CareCircle member who oversees the individual and which habits are pertinent to the individual's development and wellbeing. The system has a scheduled alarm to wake an individual daily. Upon suppressing the alarm which forces an automated check-in, an individual (e.g., a primary user) is greeted and prompted to provide information on how they are feeling, this data is collected for later analysis and is visible to the CareCircle and if not feeling well the individual is prompted to contact someone if/as needed.

Throughout the day as configured by the CareCircle member, an individual has interactions with the local device (the system as a whole) for, but not limited to, a set of adaptive routines known as habits. These adaptive habits include; a good morning habit, nutrition habit, medication habit, appointment habit, visitor habit, good evening habit, assist habit, vitals habit. Each habit provides the necessary sound, voice, visual coaching, prompts and cues to an individual. Data is collected from the system for each habit invocation and all its feedback, or lack of, from an individual throughout the course of each day. All data is secure and is stored in an encrypted state using industry standards for privacy and security. All individual and CareCircle member credentials and personal information are stored in an encrypted state using industry standards for privacy and security. The system provides visual feedback to individuals on their overall state via a local computing device. The system provides CareCircle Assisted Communications via voice, video and SMS that can be invoked via local computing device soft button, local hard buttons placed about their premise or wearable device. The local computing devices maintain constant visibility of a soft (touch) CareCircle button on every screen of the devices application. The system provides curated calling outbound or inbound from family, friends, CareCircle members, medical professionals through a one touch invocation via the local computing devices using a variety of methods, such as traditional PSTN, VoIP or cellular communications. The system provides curated music across several genres and curated news across several formats for individuals. The system provides configurable “daily start” with; appointments, local weather forecast, news and selected music configured by a CareCircle member.

The system is configured by a CareCircle member via the member's portal. A CareCircle member can configure any number of habits required for an individual to include, but not limited to, good morning habit, nutrition habit, medication habit, appointment habit, visitor habit, good evening habit, assist habit, or vitals habit. Each habit is set up for a specific individual as needed for their care plan. Each CareCircle member can support 1-N individuals that they oversee. Each CareCircle member can support an individual of another CareCircle member. CareCircle members can customize an individual's “daily start” via there portal. The CareCircle members can receive notifications on any and all habits setup and performed by the system along with responses from individuals. Each CareCircle member can provide personal contact information to be reached in the event of any CareCircle assist requests from one or more individuals. Each CareCircle member can set the priority of contact and times of day to be contacted for notifications or CareCircle assist request of individuals. Each CareCircle member can view the results of all habits, notifications and activity of individuals over the course of a day, week, month or year. Each CareCircle member can sign in when visiting an individual at their premise to; identify who has been on premise, take photo of member, perform steps via checklist, provide video notes on activity and status of individual, capture date, time and duration of visit.

Note that a routine can be triggered and launched within another routine. For example, a morning routine can trigger a medication intake routine or a vital data measurement (e.g., blood pressure, heartrate, or weight measurement) routine at certain point in time of the day. An assist routine can be launched within a morning routine or evening routine, for example, to turn on TV or turn off lights, etc.

Data collected from an individual is stored by the system for use in one or more adaptive habits. Data collected from any of the IoT devices is stored by the system for use in one or more adaptive habits. Data collected from a medical device is stored by the system for use in one or more adaptive habits. The stored medical data can be viewed by the individual or CareCircle member via the local computing device or by a CareCircle member portal on a mobile, tablet or other computing devices.

Following table illustrate examples of certain activities of a typical day of a primary user according to certain embodiments.

| Step | TOD | Activity | Action(s) |
|---|---|---|---|
| 1 | 8:00a | individual is woken up by alarm | Bedside device is in alarm mode with |
| | | from bedside mobile device, | dimmed display showing current time & |
| | | Alternates; | alarm time before alarm sounds |
| | | Lamp, e.g., smart lamp, can | When alarm sounds, display brightens & |
| | | turn on anytime during the | shows snooze & silence buttons |
| | | night based on motion | Automation (1) is triggered and turns on |
| | | (configurable) | light to bedroom |
| | | Lamp can be suppressed from | Tracker recognizes individual is awake & |
| | | turning on anytime during the | logs sleep information |
| | | night based on motion | Motion detector logs bedroom location |
| | | (configurable) | Motion detector also logs all motion in |
| | | | room during the night for analysis |
| 2 | 8:01a | individual presses “silence button”, | Automation (2) is triggered, system |
| | | and is prompted by device Speaking | speaks “good morning Faith, how are you |
| | | “good morning Faith, how are you | feeling today?” using individuals name |
| | | feeling today?”, along with display | Display show options along with image to |
| | | of options to select; 1) good, 2) ok, 3) | represent how they feel along with text |
| | | poor, need help, 4) bad, emergency | Bedside device receives input & logs |
| | | Alternates; | Tracker starts logging steps, heart rate |
| | | Can wake before alarm & stops | Motion detector logs in bedroom keeping |
| | | Can hit snooze to silence for X | light on |
| | | (configurable) minutes | |
| | | If needs assistance, notifies | |
| | | CareGiver and/or emergency | |
| | | services (configurable) | |
| 3 | 8:02a | individual presses “good” button, | Automation (3) is triggered, system starts |
| | | then is played daily information, | to play (configured) battery health of |
| | | Alternates; | tracker, current events & news |
| | | Can press a button to silence | Tracker starts logging steps, heart rate |
| | | days information | Motion detector logs in bedroom keeping |
| | | | light on |
| | | | System interprets individual feedback as |
| | | | start of day |
| 4 | 8:03a | individual gets out of bed, walking to | Tracker starts logging steps, heart rate |
| | | bathroom to get ready while | Motion detector logs in bedroom keeping |
| | | continuing to hear daily information | light on |
| 5 | 8:03a | Daily information has completed, | End of Automation (3) setup to play |
| | | and selected morning music plays | music, selected playlist is classical to start |
| | | Alternates; | day |
| | | Can change music playlist to | Audio plays over google home & mini |
| | | any other type of music | devices (casting) |
| | | Can be triggered to play | Tracker starts logging steps, heart rate |
| | | anytime | Motion detector logs in bedroom keeping |
| | | Can play different types of | light on |
| | | music at different times of the | System interprets individual feedback as |
| | | day | start of day |
| 6 | 8:05a | System reminder triggers telling | Reminder (1) fires to take medication |
| | | individual to take XYZ medication | playing an audible message & shows on |
| | | Alternates; | display of phone & tablet for input |
| | | Can run other reminders or | Tracker logs steps, heart rate, etc. |
| | | automation | Motion detector logs in bedroom keeping |
| | | Can play audio on both Google | light on |
| | | home devices | |
| | | Can display prompts on both | |
| | | mobile devices | |
| 7 | 8:15a | individual walks from bedroom to | Motion detector logs move to primary |
| | | kitchen passing through primary | living space turning on light |
| | | room to take XYZ medication | Sets auto timer to turn off bedroom light if |
| | | Alternates; | no motion for X minutes (configurable) |
| | | Meds can be in bathroom/other, | Motion detector logs move to kitchen |
| | | lights may not change | turning on light |
| | | Can add additional rooms | Sets auto timer to turn off primary room |
| | | beyond initial 2; bedroom and | light if no motion for X minutes |
| | | primary living space with | (configurable) |
| | | switch & motion | If input is required, system sets timer and |
| | | | waits for input, on timeout plays/shows |
| | | | another reminder (x times, configurable) |
| | | | Tracker logs steps, heart rate, etc. |
| 8 | 8:30a | individual takes XYZ medication | Pill dispenser sends notification to system |
| | | from pill dispenser | automatically that XYZ medication was |
| | | Alternates; | taken |
| | | Can require individual to | If manual input is required, system sets |
| | | provide feedback that | timer and waits for input, on timeout |
| | | medication was taken via | plays/shows another reminder (x times, |
| | | mobile device | configurable) |
| | | Can remind individual after X | If no manual input is required |
| | | time that input was not received | (configurable) system sets timer for x min, |
| | | | then removes input request from display |
| | | | & logs |
| | | | Motion detector logs still in kitchen |
| | | | leaving on light |
| | | | Tracker logs steps, heart rate, etc. |
| 9 | 8:35a | individual remains in kitchen, fixes | Tracker logs steps, heart rate, etc. |
| | | meal and sits to eat | Motion detector logs still in kitchen |
| | | Alternates; | keeping light on |
| | | Utilize light sensor in | |
| | | tablet/other to see if a light is | |
| | | even required to be on | |
| 10 | 9:30a | individual is done eating & asks | Via assistant, automation (4) executes |
| | | assistant to “write down what I ate” | prompting individual & starts recording to |
| | | and confirms | captures what individual says they ate for |
| | | Alternates; | later review |
| | | Not required for individual to | System plays back what individual spoke |
| | | provide feedback of what they | and asks individual to confirm |
| | | ate | System logs time meal was eaten saving |
| | | Can trigger a reminder for | recording |
| | | individual to eat if required | Tracker logs steps, heart rate, etc. |
| | | Can display for input on | Motion detector logs still in kitchen |
| | | devices if required | keeping light on |
| 11 | 9:40a | individual cleans up breakfast and | Tracker logs steps, heart rate, etc. |
| | | walks over to easy chair in primary | Motion detector logs move to primary |
| | | room | living space turning on light |
| | | Alternates; | Sets auto timer to turn off kitchen light if |
| | | none | no motion for X minutes (configurable) |
| 12 | 9:45a | individual asks assistant to “turn on | Via assistant, automation (5) turns on TV, |
| | | TV” | cable/satellite tuner, changes to specific |
| | | Alternates; | channel & logs |
| | | Can provide a reminder of | If automated, a reminder (2) will run to tell |
| | | program with no action | individual of program and ask if they want |
| | | Can fully automate to play | it turned on and set to channel |
| | | reminder of specific program | Whether asked or automated, music |
| | | and ask to turn on | stream is stopped to watch TV & logged |
| | | | If yes, the automation will perform |
| | | | functions and then play a completion |
| | | | message |
| | | | Tracker logs steps, heart rate, etc. |
| | | | Motion detector logs still in primary room |
| | | | keeping light on |
| 13 | 11:45a | individual watches TV for a couple | Tracker logs steps, heart rate, etc. |
| | | hours | Motion detector logs still in primary room |
| | | Alternates; | keeping light on |
| | | Idle state of Individual > time | A notification is sent out on individual if |
| | | triggers a reminder “get up and | their Idle time is > X time set in the |
| | | move/other” or other activity | configuration - this case the individual is |
| | | | presumed to be watching TV due to |
| | | | automation action |
| 14 | 12:00p | Someone arrives at premise and | System notifies individual and opens |
| | | rings doorbell, individual sees it is | doorbell app to see who is there |
| | | friend and tells them they will be | System logs doorbell and video |
| | | right there | Tracker logs steps, heart rate, etc. |
| | | Alternates; | Motion detector logs still in primary room |
| | | Can flash a light (even color) as | keeping light on |
| | | another signal someone is at the | |
| | | door | |
| 15 | 12:01p | individual walks to door opening and | Door sensor sees door open and logs |
| | | greets friend | Event triggers automation (6) to run, |
| | | Alternates; | announces door unlocked and door open |
| | | Can announce that the door has | System logs a visitor is at the door |
| | | been unlocked | Tracker logs steps, heart rate, etc. |
| | | Can announce that the door was | Motion detector logs still in primary room |
| | | opened | keeping light on |
| 16 | 12:02p | individual invites friend in and | Door sensor sees door now closed and |
| | | closes door | logs |
| | | Alternates; | Event triggers automation (7) to run, |
| | | Can announce that the door has | announces door locked and door closed |
| | | been locked | Tracker logs steps, heart rate, etc. |
| | | Can announce that the door was | Motion detector logs still in primary room |
| | | closed | keeping light on |
| 17 | 12:05p | Friend (Mary) having visited | Tablet app presents a screen for check-in |
| | | individual before knows to check-in | of visitors (scheduled or unscheduled) |
| | | with the app on the tablet to log | Check-in is logged |
| | | visitation | Tracker logs steps, heart rate, etc. |
| | | Alternates; | Motion detector logs still in primary room |
| | | none | keeping light on |
| 18 | 12:15p | individual and friend decide to make | Motion detector logs move to kitchen |
| | | and eat lunch and walk from primary | turning on light |
| | | room to kitchen to fix and eat | Sets auto timer to turn off primary room |
| | | Alternates; | light if no motion for X minutes |
| | | none | (configurable) |
| | | | Tracker logs steps, heart rate, etc. |
| | | | Motion detector logs still in primary room |
| | | | keeping light on |
| 19 | 1:15p | individual and friend are done eating | Via assistant, automation (8) executes |
| | | & asks assistant to “write down what | prompting individual & starts recording to |
| | | I ate” and confirms | captures what individual says they ate for |
| | | Alternates; | later review |
| | | Not required for individual to | System plays back what individual spoke |
| | | provide feedback of what they | and asks individual to confirm |
| | | ate | System logs time meal was eaten saving |
| | | Can trigger a reminder for | recording |
| | | individual to eat if required | Tracker logs steps, heart rate, etc. |
| | | Can display for input on | Motion detector logs still in kitchen |
| | | devices if required | keeping light on |
| 20 | 1:30p | System reminder triggers telling | Reminder (3) fires to take medication |
| | | individual to take ABC medication | playing an audible message & shows on |
| | | Alternates; | display of phone & tablet for input |
| | | Can run other reminders or | Tracker logs steps, heart rate, etc. |
| | | automation | Motion detector logs in bedroom keeping |
| | | Can play audio on both Google | light on |
| | | home devices | |
| | | Can display prompts on both | |
| | | mobile devices | |
| 21 | 1:33p | individual takes ABC medication | Pill dispenser sends notification to system |
| | | from pill dispenser | automatically that ABC medication was |
| | | Alternates; | taken |
| | | Can require individual to | If manual input is required, system sets |
| | | provide feedback that | timer and waits for input, on timeout |
| | | medication was taken via | plays/shows another reminder (x times, |
| | | mobile device | configurable) |
| | | Can remind individual after X | If no manual input is required |
| | | time that input was not received | (configurable) system sets timer for x min, |
| | | | then removes input request from display |
| | | | & logs |
| | | | Motion detector logs still in kitchen |
| | | | leaving on light |
| | | | Tracker logs steps, heart rate, etc. |
| 22 | 3:45p | individual and friend talk for a | Motion detector logs move to primary |
| | | couple hours then friend leaves, | room turning on light |
| | | individual walks friend from kitchen | Sets auto timer to turn off kitchen light if |
| | | to primary room | no motion for X minutes (configurable) |
| | | Alternates; | Tracker logs steps, heart rate, etc. |
| | | none | Motion detector logs still in primary room |
| | | | keeping light on |
| 23 | 3:47p | Friend having visited individual | Tablet app presents a screen for check-out |
| | | before knows to check-out on the | of visitors (scheduled or unscheduled) |
| | | app on the tablet to log end of | Check-out is logged |
| | | visitation then exits premise, door | Door sensor sees door open then closed |
| | | locks | and logs |
| | | Alternates; | Event triggers automation (7) to run, |
| | | none | announces door locked and door closed |
| | | | Tracker logs steps, heart rate, etc. |
| | | | Motion detector logs still in primary room |
| | | | keeping light on |
| 24 | 3:48p | individual walks from door to tablet | Tracker logs steps, heart rate, etc. |
| | | in primary living space | Motion detector logs still in primary room |
| | | Alternates; | keeping light on |
| | | none | |
| 25 | 3:50p | Individual wants to see how she is | Tablet app presents individual data screen |
| | | doing for the day pressing an “about | showing details of all activity |
| | | me” (or other) button. | After X amount of time, display changes |
| | | Alternates; | back to default screen |
| | | Can ask via assistant “about | Tracker logs steps, heart rate, etc. |
| | | me” | Motion detector logs still in primary room |
| | | | keeping light on |
| 26 | 4:00p | individual returns to easy chair in | Tracker logs steps, heart rate, etc. |
| | | primary living space and returns to | Motion detector logs still in primary room |
| | | watching TV | keeping light on |
| | | Alternates; | |
| | | none | |
| 27 | 4:15p | While watching TV, individual is | System during announcement of call, |
| | | notified of an incoming video call | shows picture of daughter from contact |
| | | from daughter (via tablet), systems | list |
| | | announces “Jessica is calling, would | On reply of “yes” through screen system |
| | | you like to talk”? Individual replies | answers video call and initiates 2 ways |
| | | “yes” | voice/video |
| | | Alternates; | System initiates video call logging who it |
| | | Can have call event trigger to | is, time, date |
| | | turn down TV volume | Tracker logs steps, heart rate, etc. |
| | | Can have call event trigger to | Motion detector logs still in primary room |
| | | turn off TV & tuner | keeping light on |
| 28 | 4:55p | individual and daughter talk for 40 | Motion detector logs primary room |
| | | minutes then hang up | location |
| | | Alternates; | Tracker logs steps, heart rate |
| | | none | System tracks duration of video call |
| 29 | 5:00p | individual decides it dinner time and | Motion detector logs move to kitchen |
| | | walks from primary living space to | turning on light |
| | | kitchen, fixes simple dinner and eats | Sets auto timer to turn off primary room |
| | | Alternates; | light if no motion for X minutes |
| | | Can have reminder tell | (configurable) |
| | | Individual time to eat | Tracker logs steps, heart rate, etc. |
| | | | Motion detector logs still in primary room |
| | | | keeping light on |
| 30 | 5:45p | individual is done eating & asks | Via assistant, automation (9) executes |
| | | assistant to “write down what I ate” | prompting individual & starts recording to |
| | | and confirms | captures what individual says they ate for |
| | | Alternates; | later review |
| | | Not required for individual to | System plays back what individual spoke |
| | | provide feedback of what they | and asks individual to confirm |
| | | ate | System logs time meal was eaten saving |
| | | Can trigger a reminder for | recording |
| | | individual to eat if required | Tracker logs steps, heart rate, etc. |
| | | Can display for input on | Motion detector logs still in kitchen |
| | | devices if required | keeping light on |
| 31 | 6:00p | System reminder triggers telling | Reminder (3) fires to take medication |
| | | Individual to take ABC medication | playing an audible message & shows on |
| | | Alternates; | display of phone & tablet for input |
| | | Can run other reminders or | Tracker logs steps, heart rate, etc. |
| | | automation | Motion detector logs in bedroom keeping |
| | | Can play audio on both Google | light on |
| | | home devices | |
| | | Can display prompts on both | |
| | | mobile devices | |
| 32 | 6:01p | individual takes ABX medication | Pill dispenser sends notification to system |
| | | from pill dispenser | automatically that ABX medication was |
| | | Alternates; | taken |
| | | Can require individual to | If manual input is required, system sets |
| | | provide feedback that | timer and waits for input, on timeout |
| | | medication was taken via | plays/shows another reminder (x times, |
| | | mobile device | configurable) |
| | | Can remind individual after | If no manual input is required |
| | | X time that input was not | (configurable) system sets timer for x min, |
| | | received | then removes input request from display |
| | | | and logs |
| | | | Motion detector logs still in kitchen |
| | | | leaving on light |
| | | | Tracker logs steps, heart rate, etc. |
| 33 | 6:15p | individual decides to watch a little | Via assistant, automation (10) turns on |
| | | more TV before going to bed and | TV, cable/satellite tuner, changes to |
| | | walks from kitchen to primary living | specific channel & logs |
| | | space and resumes watching TV | Whether asked or automated, music |
| | | Alternates; | stream is stopped to watch TV & logged |
| | | Can provide a reminder of | If yes, the automation will perform |
| | | program with no action | functions and then play a completion |
| | | Can fully automate to play | message |
| | | reminder of specific program | Tracker logs steps, heart rate, etc. |
| | | and ask to turn on | Motion detector logs still in primary room |
| | | | keeping light on |
| 34 | 8:15p | individual is tired and decides to go | Via assistant, automation (11) turns off |
| | | to bed, tells system to turn off TV, | TV, cable/satellite tuner & logs |
| | | walks from primary living space to | Whether asked or automated, music |
| | | bedroom | stream is started when TV if turned off, |
| | | Alternates; | set to play light Jazz for 1 hr. beyond |
| | | Idle state of individual > time | (configurable) pressing “go to bed” |
| | | triggers a reminder “get up and | Tracker logs steps, heart rate, etc. |
| | | move/other” or other activity | Motion detector logs still in primary room |
| | | Set different audio to play | keeping light on |
| | | | A notification is sent out on individual if |
| | | | their Idle time is > X time set in config - |
| | | | this case the individual is presumed to be |
| | | | watching TV due to automation action |
| 35 | 8:20p | individual gets ready for bed | Motion detector logs move to bedroom |
| | | Alternates; | turning on light |
| | | none | Sets auto timer to turn off primary room |
| | | | light if no motion for X minutes |
| | | | (configurable) |
| | | | Tracker logs steps, heart rate, etc. |
| 36 | 8:30p | individual presses “go to bed” on the | Motion detector logs bedroom location |
| | | bedside device, lays down and | Tracker logs steps, heart rate |
| | | proceeds to go to sleep (check out), | Tracker recognizes sleep and starts |
| | | system prompts for “how she feels”, | logging individual sleep for the night |
| | | individual responds “good” | system turns off all lighting when |
| | | Alternates; | individual presses “go to bed” (just in case |
| | | Responds “not good” which | some did not go out prior) |
| | | would invoke questions for | |
| | | requesting to call someone | |
| | | End of use case | |

Dependent upon the specific configuration, for some of the events, notifications may be transmitted to one or more secondary users who have subscribed the notification. An example of typical activities of a secondary user device of a secondary user is shown in the table below, which is synchronized in steps and time of day (TOD) with the primary user's activities shown in the table above.

| Step | TOD | Activity | Action(s) |
|---|---|---|---|
| 1 | 8:00a | CareGiver is notified: | System records ALL events |
| | | “Alarm Sounding” | events; alarm |
| 2 | 8:01a | CareGiver is notified: | System records ALL events |
| | | “Alarm Silenced” | events; awake, bedroom, lights on |
| | | “Individual is awake” | Logs events and triggers workflow |
| | | “In bedroom” | workflow set to send notification via |
| | | “bedroom lights on” | SMS (can also use mobile notification |
| | | “Show sleep vitals” | service) |
| | | | Notification level for detail sent can be |
| | | | adjusted by CareGiver |
| | | | Vitals have a link back to the portal to |
| | | | view if clicked |
| | | | Any number of notifications from |
| | | | ALL to Emergency ONLY can be set |
| 3 | 8:02a | CareGiver is notified: | System records ALL events |
| | | “Individual feeling good” | events; feeling good, bedroom, lights |
| | | “Tracker battery 80%” | on |
| | | “Current events and news” | Logs events and triggers workflow |
| | | “In bedroom” | workflow set to send notification via |
| | | “bedroom lights on” | SMS (can also use mobile notification |
| | | | service) |
| 4 | 8:03a | No notification | System records ALL events |
| | | | events; daily info end, bedroom, lights |
| | | | on |
| 5 | 8:03a | No notification | System records ALL events |
| | | | events; music play classical, bedroom, |
| | | | lights on |
| 6 | 8:05a | CareGiver is notified: | System records ALL events |
| | | “Medication reminder” | events; med reminder, bedroom, lights |
| | | “In bedroom” | on |
| | | “bedroom lights on” | Logs events and triggers workflow |
| | | | workflow set to send notification via |
| | | | SMS (can also use mobile notification |
| | | | service) |
| 7 | 8:15a | No notification | System records ALL events |
| | | | events; music play classical, home & |
| | | | mini |
| 8 | 8:30a | CareGiver is notified: | System records ALL events |
| | | “Take medication” | events; take med, in kitchen, lights on, |
| | | “In kitchen” | music play classical, home & mini |
| | | “kitchen lights on” | Logs events and triggers workflow |
| | | “Show vitals” | workflow set to send notification via |
| | | | SMS (can also use mobile notification |
| | | | service) |
| 9 | 8:35a | No notification | System records ALL events |
| | | | events; music play classical, home & |
| | | | mini, kitchen, lights on |
| 10 | 9:30a | No notification | System records ALL events |
| | | | events; music play classical, home & |
| | | | mini, ate meal, kitchen, lights on |
| | | | Recording available for review |
| 11 | 9:40a | No notification | System records ALL events |
| | | | events; music play classical, home & |
| | | | mini, primary room, lights on |
| 12 | 9:45a | No notification | System records ALL events |
| | | | events; music off, TV/tuner on, set |
| | | | channel, primary room, lights on |
| 13 | 11:45a | CareGiver is notified: | System records ALL events |
| | | “In primary room” | events; idle, primary room, lights on, |
| | | “ lights on” | TV/tuner on |
| | | “Idle >1.5 hrs” | Logs events and triggers workflow |
| | | “Show vitals” | workflow set to send notification via |
| | | | SMS (can also use mobile notification |
| | | | service) |
| 14 | 12:00p | CareGiver is notified: | System records ALL events |
| | | “In primary room” | events; doorbell, primary room, lights |
| | | “ lights on” | on, TV/tuner on |
| | | “Doorbell ring” | Logs events and triggers workflow |
| | | “Show vitals” | workflow set to send notification via |
| | | | SMS (can also use mobile notification |
| | | | service) |
| 15 | 12:01p | CareGiver is notified: | System records ALL events |
| | | “In primary room” | events; door open, visitor, primary |
| | | “ lights on” | room, lights on, TV/tuner on |
| | | “Door open” | Logs events and triggers workflow |
| | | “visitor” | workflow set to send notification via |
| | | “Show vitals” | SMS (can also use mobile notification |
| | | | service) |
| 16 | 12:02p | CareGiver is notified: | System records ALL events |
| | | “In primary room” | events; door open, visitor, primary |
| | | “ lights on” | room, lights on, TV/tuner on |
| | | “Door open” | Logs events and triggers workflow |
| | | “visitor” | workflow set to send notification via |
| | | “Show vitals” | SMS (can also use mobile notification |
| | | | service) |
| 17 | 12:05p | CareGiver is notified: | System records ALL events |
| | | “In primary room” | events; door closed, visitor check-in, |
| | | “primary lights on” | visitor identified, primary room, lights |
| | | “Door closed” | on, TV/tuner on |
| | | “Door locked” | Logs events and triggers workflow |
| | | “Visitor is Mary” | workflow set to send notification via |
| | | “Show vitals” | SMS (can also use mobile notification |
| | | | service) |
| 18 | 12:15p | No notification | System records ALL events |
| | | | Events; kitchen, lights on, TV/tuner |
| | | | on |
| | | | Logs events and triggers workflow |
| | | | workflow set to send notification via |
| | | | SMS (can also use mobile notification |
| | | | service) |
| 19 | 1:15p | No notification | System records ALL events |
| | | | events; ate meal, kitchen, lights on, |
| | | | TV/tuner on |
| | | | Recording available for review |
| 20 | 1:30p | CareGiver is notified: | System records ALL events |
| | | “Medication reminder” | events; med reminder, in kitchen, |
| | | “In bedroom” | lights on, TV/tuner on |
| | | “bedroom lights on” | Logs events and triggers workflow |
| | | | workflow set to send notification via |
| | | | SMS (can also use mobile notification |
| | | | service) |
| 21 | 1:33p | CareGiver is notified: | System records ALL events |
| | | “Take medication” | events; take med, in kitchen, lights on, |
| | | “In kitchen” | TV/tuner on |
| | | “kitchen lights on” | Logs events and triggers workflow |
| | | “Show vitals” | workflow set to send notification via |
| | | | SMS (can also use mobile notification |
| | | | service) |
| 22 | 3:45p | No notification | System records ALL events |
| | | | events; primary room, lights on, |
| | | | TV/tuner on |
| | | | Recording available for review |
| 23 | 3:47p | CareGiver is notified: | System records ALL events |
| | | “In primary room” | events; door open, door closed, visitor |
| | | “primary lights on” | identified, visitor check out, primary |
| | | “Door opened” | room, lights on, TV/tuner on |
| | | “Door closed” | Logs events and triggers workflow |
| | | “Door locked” | workflow set to send notification via |
| | | “Visitor is Mary” | SMS (can also use mobile notification |
| | | “Show vitals” | service) |
| 24 | 3:48p | No notification | System records ALL events |
| | | | events; primary room, lights on, |
| | | | TV/tuner on |
| | | | Recording available for review |
| 25 | 3:50p | No notification | System records ALL events |
| | | | events; stats view, primary room, |
| | | | lights on, TV/tuner on |
| 26 | 4:00p | No notification | System records ALL events |
| | | | events; primary room, lights on, |
| | | | TV/tuner on |
| 27 | 4:15p | CareGiver is notified: | System records ALL events |
| | | “In primary room” | events; call unscheduled, primary |
| | | “primary lights on” | room, lights on, TV/tuner on |
| | | “Call from Jessica” | Logs events and triggers workflow |
| | | “unscheduled” | workflow set to send notification via |
| | | “Show vitals” | SMS (can also use mobile notification |
| | | | service) |
| 28 | 4:55p | No notification | System records ALL events |
| | | | events; call end, primary room, lights |
| | | | on, TV/tuner on |
| 29 | 5:00p | No notification | System records ALL events |
| | | | events; kitchen, lights on, TV/tuner on |
| 30 | 5:45p | No notification | System records ALL events |
| | | | events; ate meal, kitchen, lights on, |
| | | | TV/tuner on |
| | | | Recording available for review |
| 31 | 6:00p | CareGiver is notified: | System records ALL events |
| | | “Medication reminder” | events; med reminder, in kitchen, |
| | | “In bedroom” | lights on, TV/tuner on |
| | | “bedroom lights on” | Logs events and triggers workflow |
| | | | workflow set to send notification via |
| | | | SMS (can also use mobile notification |
| | | | service) |
| 32 | 6:01p | CareGiver is notified: | System records ALL events |
| | | “Take medication” | events; take med, in kitchen, lights on, |
| | | “In kitchen” | TV/tuner on |
| | | “kitchen lights on” | Logs events and triggers workflow |
| | | “Show vitals” | workflow set to send notification via |
| | | | SMS (can also use mobile notification |
| | | | service) |
| 33 | 6:15p | No notification | System records ALL events |
| | | | events; primary room, lights on, |
| | | | TV/tuner on |
| | | | Recording available for review |
| 34 | 8:15p | No notification | System records ALL events |
| | | | events; bedroom, lights on, TV/tuner |
| | | | off |
| | | | Recording available for review |
| 35 | 8:20p | No notification | System records ALL events |
| | | | events; bedroom, lights on |
| | | | Recording available for review |
| 36 | 8:30p | CareGiver is notified: | System records ALL events |
| | | “Go to bed” | events; go to bed, bedroom, lights off |
| | | “In bedroom” | Logs events and triggers workflow |
| | | “bedroom lights off' | workflow set to send notification via |
| | | “Show vitals” | SMS (can also use mobile notification |
| | | | service) |
| 37 | 8:45p | CareGiver wishes to review the | System provides portal with secure |
| | | Individuals full day of activity and goes | SSL/TLS encryption |
| | | to Routinify website | Site information for access provided |
| | | | by Concierge Specialist |
| 38 | 8:46p | CareGiver logs into website | Uses credentials provided by |
| | | | Concierge Specialist |
| 39 | 8:47p | CareGiver is presented dashboard and | System presents the dashboard which |
| | | reviews; | is a calendar based tracking of all |
| | | High Level view of activity | activity performed by the Individual |
| | | Click on sleep activity to view | and tracked by the system via all |
| | | Clicks on meal link to listen | devices in the environment |
| | | Views other details | System serves up content for |
| | | Makes changes to med reminder, | CareGivers view as requested |
| | | does not want to get notification, | |
| | | just for meds taken | |
| 40 | 9:15p | CareGiver is done and logs out of system | System logs all activity of CareGiver |
| | | | and logs them out of the system |
| | | End of use case | |

All of the above events occurred during the day are recorded as a part of event log for the primary user, which may be analyzed using a machine learning engine to improve the related routines. As described above, examples of the routines can include, but they are not limited to, CareCircle assist routine 311, morning routine 312, night routine 313, nutrition routine 314, vital measurement routine 315, appointment routine 316, assist routine 317, visitor routine 318, and medication intake routine 319 of FIG. 3. Some of routines 311-319 can be integrated into an integrated routine. Any one of routines 311-319 can trigger and launch another one or more of routines 311-319.

According to one embodiment, in supporting a CareCircle assist routine, the system is built to provide help (e.g., panic help) and emergency communication to a group of individuals (e.g., secondary users, CareCircle members) to support an individual living at home (e.g., primary user) when assistance or other services are needed/required.

The system is built to support CareCircle assist requests via soft button on a mobile application and/or via hard button placed anywhere on a premise. The button pressed invokes system to process the setup of live CareCircle communications. The system identifies specific individuals (e.g., primary user) making a CareCircle assist request. The system collects list of CareCircle members (e.g., secondary users) for the specific individual. The CareCircle list size can be 1-N in size and is set in priority order of who to call first vs last. The system creates on demand, secure voice or video communications to connect all parties called. The system initiates a voice or video call to the individual and automatically connects. The system enables speaker and video on device without individual's intervention. The system announces each CareCircle member as they are added to communications.

Using the CareCircle list, the system sends an SMS (short messaging service) message to the first CareCircle member. The SMS message contains the individual name, time of event, a callback number, a security PIN number, etc. The system initiates voice or video call to first CareCircle member and will connect to CareCircle member if called number is answered. Once call is answered, the system will prompt to enter security pin obtained from SMS message, and once security pin is entered correctly (No pin is required if answering from device called), the called member is added to the group conference communications. If the call is not answered, the system will proceed to next CareCircle member in the list. If none of the CareCircle members are connected, a back stop service, available 7/24 can be contacted so the CareCircle assist request does not go unanswered.

At any time a CareCircle member who received the SMS message but either did not receive a call or could not answer is able to connect using the callback number and PIN provided in the SMS message. The pin is only required if call in from a different phone than the one registered with the system. At any time a designated CareCircle member in the group communications can break away from the group communications to contact the necessary emergency services, and once connected the CareCircle member can add themselves, as well as emergency services, to the group communications.

Each CareCircle member receives an automatically generated and on demand SMS message with information on how to manually connect to the group communications. Each CareCircle member is automatically called sequentially by the system once the CareCircle list is obtained. Each CareCircle member is automatically connected in a voice or video call to the system and each CareCircle member is authenticated via the PIN from the SMS message to add to voice or video communications.

Each CareCircle member is automatically connected to group communications allowing the member to converse with the individual and all other CareCircle members in live communications. The system automatically enables, if configured, call recording of the entire communications session. If a CareCircle member adds emergency services to the group communications, information about the individual can be sent to emergency services via an SMS, data link or other electronic communications method.

The system will announce to the member, each CareCircle member that has been joined in the communications and each CareCircle member being added to conference. Real-time SMS updates are sent to CareCircle members every x minutes during the communications setup to inform members of all currently in communications with the individual. A real-time dashboard within the CareCircle member's portal shows the state of each member called: calling, called and answered, called with no answer, called and authenticating, in group communications, dropped off/disconnected. The state of each CareCircle member is updated regardless of whether called in sequence or via blast CareCircle calling which is configurable.

Below is a table showing an example of activities or events occurred during a CareCircle assist routine, which may be triggered in response to an activation of a CareCircle button by a primary user.

| Step | TOD | Activity | Action(s) |
|---|---|---|---|
| 1 | 2:25 | individual pushes Soft CareCircle | CareCircle button press received |
| | pm | assist button on Bedside SA app | CareCircle automation initiated |
| | | Message Examples | Android device displays Help messages |
| | | CareCircle Pressed (visual & audible): | Android device plays “CareCircle |
| | | “CareCircle pressed” | requested, preparing to contact help, |
| | | Countdown (visual & audible): | press button to cancel” and initiates a 5 |
| | | “getting assistance, in 5” | second visual and audible countdown |
| | | “4” | If button is pressed during countdown, |
| | | “3” | request is halted and “CareCircle |
| | | “2” | request canceled” is displayed and |
| | | “1” | audibly announced |
| | | Calling CareCircle (visual & audible): | An event should be sent from the |
| | | “calling family (and/or CareGiver)” | SA app to Routinify to log with no |
| | | Notification Sent (visual only): | action to be taken |
| | | “message sent to family (and/or | If button is NOT pressed, automation |
| | | CareGiver)” | timeout occurs and proceeds to reach |
| | | Call Connected (visual): | out to contacts |
| | | “Show picture & status of individual” | |
| | | CareCircle Canceled (visual & | |
| | | audible) | |
| | | “CareCircle request canceled” | |
| 2 | 2:26 | Bedside SA app sends CareCircle | CareCircle request sent from phone |
| | pm | request to Routinify via local network | over WiFi connection to Routinify |
| | | WiFi | systems |
| | | | If using HA panic package, panic |
| | | | buttons would use WiFi hotspot instead |
| | | | of home WiFi see drawing for flow |
| | | | details |
| 3 | 2:26p | Routinify invokes panic request to | communications cloud returns ongoing |
| | | communications cloud for SMS and | status to Routinify of each call to panic |
| | | Voice, along with configured | list contacts |
| | | CareCircle contact list (phone/SMS | Routinify provides communications |
| | | numbers) | cloud STATUS for each contact; |
| | | | CONNECTED/show image |
| | | | NOT connected/image not shown |
| | | | Talking/NOT talking |
| | | | Include if connected later in bridge |
| | | | Status provided during connection setup |
| | | | & through duration of bridge is |
| | | | disconnected |
| 4 | 2:26p | Routinify sends CareCircle contact list | CareCircle list info includes; contact |
| | | info to SA app | name, number, photo (link), etc. |
| | | | Routinify will update the app about |
| | | | each participants status so display |
| | | | updates can be made |
| 5 | 2:26p | communications cloud sends SMS | Phone sends a custom SMS message to |
| | | messages to all contacts to inform of | all CareGiver/Family contacts to join |
| | | event with contact number, | bridge (optionally configured) |
| | | communications cloud updates | CareGiver/Family members can click |
| | | Routinify with status, Routinify updates | link and call into bridge and connect if |
| | | SA App with status | they were unable to answer automated |
| | | | call from communications cloud |
| 6 | 2:26p | At same time SMS are sent, | communications cloud contacts |
| | | communications cloud places voice | individuals SA apps with VoIP voice |
| | | calls to all contact numbers, | call and auto connects without |
| | | communications cloud updates | individuals manual intervention |
| | | Routinify with status, Routinify updates | SA App on both Bedside and Main |
| | | SA App with status | living space are connected to bridge |
| | | | External speaker & mic utilized via |
| | | | Bedside and Main living device for |
| | | | individual to talk hands free |
| 7 | 2:26p | As CareGiver and Family members | CallID on panic contacts phone reads |
| | | answer CareCircle calls connected are | “CareCircle assist requested” |
| | | bridged into a group conference call to | Limit the number of individuals on |
| | | discuss individuals situation, | CareCircle list to 2-3 (1-individual, |
| | | communications cloud updates | 2-CareGiver, 3-Family member, only |
| | | Routinify with status, Routinify updates | above 3 if adding 911/other-special |
| | | SA App with status | case) |
| | | | Other people can be added like 911 or |
| | | | other experts as needed |
| | | | CareGiver web app would include |
| | | | number for local police in individual |
| | | | area for 911 service needs to contact if |
| | | | emergency services are needed |
| 8 | 2:28p | CareGiver determines that emergency | CareGiver web app has button tied to |
| | | services are needed and clicks a button | local police/emergency in individuals |
| | | on the web app to call emergency | area (configured item in Routinify) |
| | | services separate from the bridge call | communications cloud puts CareGiver |
| | | using communications cloud, | on hold (no music) breaking away from |
| | | communications cloud updates | the bridge and calls to a preconfigured |
| | | Routinify with status, Routinify updates | emergency number for the individuals |
| | | SA App with status | local area (automatically) |
| 9 | 2:30p | CareGiver reconnects to bridge with the | Once the emergency personnel is on |
| | | emergency personnel and determine | with the CareGiver, the CareGiver can |
| | | steps to take due to situation | click a “reconnect to bridge” button to |
| | | | return to the bridge with the emergency |
| | | | person bridged in also |
| 10 | 2:35p | Bridge call is completed and CareGiver | individual is enabled with hands free |
| | | closes bridge, communications cloud | speaker calling |
| | | updates Routinify with status, Routinify | CareGiver presses “bridge complete” to |
| | | updates SA App with status | end and complete bridge |
| | | | All information logged including audio |
| | | | recording and link for playback |
| | | | All connections are dropped upon |
| | | | completion |

Dependent upon the notification configuration, below table shows examples of activities or events of a secondary user occurred during the panic routine, which is synchronized in steps and TOD with respect to the above panic routine example.

| Step | TOD | Activity | Action(s) |
|---|---|---|---|
| 1 | 2:25 | No notification | System records ALL events |
| | pm | | events; CareCircle, CareCircle |
| | | | timeout, CareCircle cancel, message |
| | | | displayed, message played |
| 2 | 2:26 | No notification | System records ALL events |
| | pm | | events; CareCircle notification |
| 3 | 2:26p | No notification | System records ALL events |
| | | | events; CareCircle notification |
| 4 | 2:26p | No notification | System records ALL events |
| | | | events; CareCircle notification |
| 5 | 2:26p | CareGiver receives custom SMS | System records ALL events |
| | | message with info and bridge number to | events; CareCircle SMS |
| | | call | SMS received has a message like |
| | | | “CareCircle button pressed at |
| | | | individual X, call into bridge ASAP, |
| | | | bridge 303-555-1234” |
| | | | Bridge is custom to individual |
| | | | Message custom to CareGiver |
| | | | Can optionally receive message of |
| | | | “CareCircle canceled” |
| 6 | 2:26p | CareGiver receives automated call from | System records ALL events |
| | | communications cloud to bridge into | events; panic call |
| | | call | |
| 7 | 2:26p | CareGiver answers call and is auto | System records ALL events |
| | | connected into bridge | events; CareCircle call bridged |
| | | | bridge system logging call |
| | | | Bridge system provides information |
| | | | regarding which CareGiver/Family |
| | | | member joined |
| 8 | 2:28p | CareGiver presses “emergency | System records ALL events |
| | | services” button in web app to contact | events; emergency services |
| | | emergency services | communications cloud puts CareGiver |
| | | | on hold (no music) breaking away from |
| | | | the bridge and calls to a preconfigured |
| | | | emergency number for the individuals |
| | | | local area (automatically) |
| 9 | 2:30p | CareGiver presses “reconnect to bridge” | System records ALL events |
| | | button in web app to return to bridge | events; emergency bridged |
| | | with emergency personnel | |
| 10 | 2:35p | CareGiver presses “bridge complete” | System records ALL events |
| | | button in web app to disconnect all from | Events; Disconnect Bridge |
| | | bridge (complete) | CareGiver is able to type notes into the |
| | | | web system regarding the CareCircle |
| | | | assist |

The system can utilize machine learning on the events to identify the trend and need for modified use of actual “help” related communications vs “CareCircle” communications. Based on learning, for example, the system can determine if countdown time can be adjusted to reflect “extra time” or “less time” needed to determine whether to cancel or not. A user can select switch in configuration to “allow” to opt in or “not allow” to opt out adaptable change to take place. The user can also constrain to a min and max time to dynamically adjust either “extra” or “less” time in x seconds (default=5 seconds) increments.

For any other routines such as routines 312-319, an authorized person can configure and set up the routine via a configuration interface such as a Web portal associated with routine management system 101 and handled by configuration module 204.

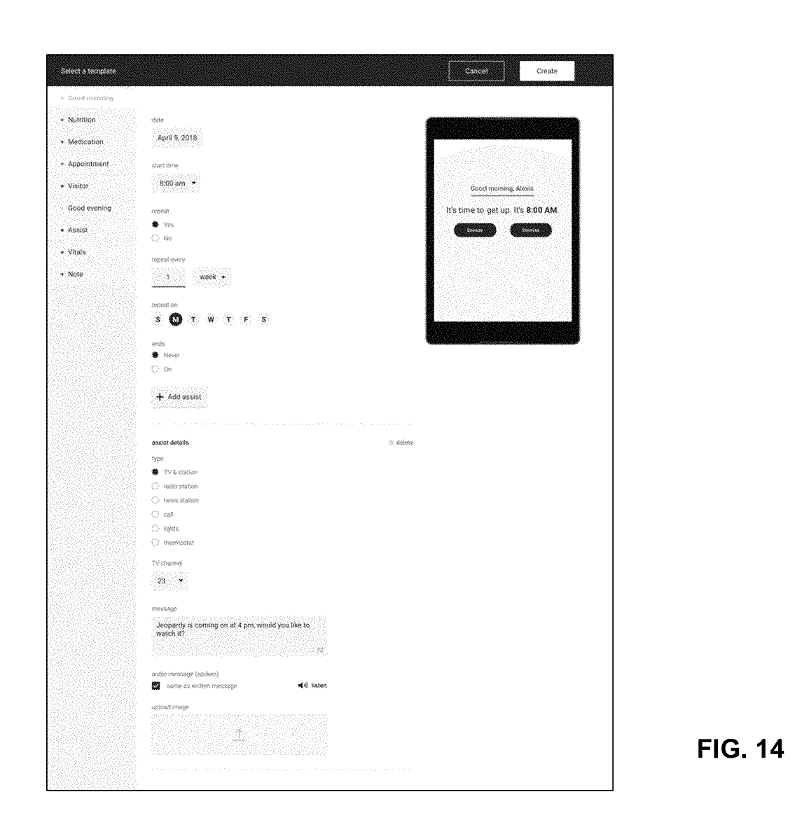

FIG. 14 is a screenshot illustrating an example of a graphical user interface (GUI) for configuring a morning routine according to one embodiment. Referring to FIG. 14, which shows a morning routine template, an authorized person can set up the date and starting time of a morning routine, indicate whether the routine will be repeatedly executed, and which day of the week the routine will be repeatedly executed. A user can also specify a message transmitted to a primary user device and to be displayed thereon. A content item such as a media content (e.g., audio, image, video) can be uploaded, where the content item can be transmitted to the primary user device to be prompted and played thereon. The media content can be automatically converted by the system from the message entered therein, for example by clicking the checkbox of “same as written message.” In addition, one or more assist routines can be added, such as assistance on TV, radio, calling someone, etc., for example, by clicking the “add assist” button. An example of the user interface or presentation that will be displayed at the primary user device is also shown on the right upper corner.

An example of morning routine 312 is shown in the table below according one embodiment.

| Step | Individual Activity | Function | Type/Description |
|---|---|---|---|
| 0 | none | chime | Chime sound is invoked to get the |
| | | | Individuals attention for a scheduled |
| | | | routine, system is in night mode, prior to |
| | | | alarm time |
| 1 | Morning scheduled alarm sounds | none | At scheduled time, “good morning” |
| | | | routine is executed |
| 2 | Individual silences scheduled alarm | trigger | Alarm “dismiss” triggers routine, which is |
| | | | mapped to “good morning” routine |
| 3 | none | check | Individual is automatically check into the |
| | | | Routinify system for start of new day |
| 4 | none | routine | Good morning executes |
| 6 | Individual is greeted by the system; | show-n-tell | Show SmartTab display visual and play |
| | Visual Cue: presented text, “good | | TTS (text to speech) |
| | morning Jessica, how are you | | |
| | feeling today?”, along with “good” | | |
| | and “bad” selection buttons | | |
| | Audible Cue: plays TTS “good | | |
| | morning Jessica, how are you | | |
| | feeling today?” over SmartTab | | |
| | display speakers | | |
| 7 | Individual is prompted to press button | if | Test for button press |
| | for “ . . . how are you feeling” | | |
| | If “good” pressed, step 8 | | |
| | If “bad” pressed, step 30 | | |
| 8 | Individual presses “good” button | response | Individual button press, |
| 9 | none | continue | Proceeds to next step in routine |
| 10 | Individual is presented with the current | show | Show SmartTab display visual and play |
| | weather in her area | | TTS, |
| | Visual Cue: presented textual | | |
| | and graphical display of | | |
| | weather | | |
| 11 | Individual is presented with the current | play | Weather audio stream from weather |
| | weather in her area | | service, |
| | Audible Cue: presented with | | |
| | audio update of weather by | | |
| | weather service over | | |
| | SmartTab display speakers | | |
| 12 | Weather update is complete | continue | Proceeds to next step in routine |
| 13 | Individual is presented with current | show | Show SmartTab display visual and play |
| | news setup in configuration | | TTS, |
| | Visual Cue: presented textual | | |
| | and graphical display of news | | |
| | stream | | |
| 14 | Individual is presented with current | play | news audio stream from google music |
| | news setup in configuration | | service, |
| | Audible Cue: presented with | | |
| | audio update of news stream | | |
| | over SmartTab display | | |
| | speakers | | |
| 15 | News update is complete | continue | Proceeds to next step in routine |
| 16 | Individual is presented with current | show | Show SmartTab display visual and play |
| | radio station (Sinatra) setup in | | TTS, |
| | configuration | | |
| | Visual Cue: presented textual | | |
| | and graphical display of radio | | |
| | station stream | | |
| 17 | Individual is presented with current | play | news audio stream from google music |
| | news setup in configuration | | service, |
| | Audible Cue: presented with | | |
| | audio of radio stream over | | |
| | SmartTab display speakers | | |
| 18 | none | timerSet | Timer set for 1 hour to play music, then set |
| | | | to end radio stream |
| 19 | none | timerExpire | Timer expires, routine proceed to next |
| | | | step |
| 20 | none | home | Tells android app to exit current screen |
| | | | and goto home screen |
| 21 | none | end | End of routine, terminates execution |
| | Branch from step 8 | | |
| 30 | Individual is prompted with | show | Show SmartTab display visual |
| | Visual Cue: presented text, | | |
| | “would you like to call | | |
| | someone?”, along with “yes’ | | |
| | and “no” selection buttons | | |
| 31 | Individual is prompted to press button | if | Test for button press |
| | for “ . . . call someone?” | | |
| | If “yes” pressed, step 40 | | |
| | If “no” pressed, step 32 | | |
| 32 | Individual presses “no” button | response | Individual button press, |
| 33 | Individual is prompted by the system; | show | Show SmartTab display visual, |
| | Visual Cue: presented text, | | |
| | “sorry you are not feeling | | |
| | well. We'll keep an eye on | | |
| | you.”, along with “okay” | | |
| | button | | |
| | If “okay” pressed, step 10 | | |
| | Branch from step 32 | | |
| 40 | Individual is connected into a care | call | System invokes call/message to care |
| | group call | | group and connects as they accept or dial |
| | | | in |
| | End of “good morning” routine | | |

All of the events and activities are recorded and stored in an event log, which can be analyzed subsequently. The system utilizes machine learning to identify trend and need for modification. For example, based on silence vs snooze per day by the primary user, the system can identify an optimum time for an individual to wake up, in conjunction with the night routine, can dynamically change time over course of a period of time such as a few days to adjust to a better time set to improve sleep, etc. Based on the feeling of the primary user (e.g., feedback), the system can identify over time through CareGiver feedback and “not good” button press from the primary user that a call should be made instead of just a notification especially if the Individual has declined a call to someone (proactive contact). Further, the system can determine what is and is not listened to daily, identify frequency of information listened to over time, identify items manually selected to listen to separate from briefing, dynamically change the content based on briefing and manual listening analysis, and dynamically change the days and frequency content would be listened to. Such adjustments can be opted in or out dependent upon the user configuration.

According to one embodiment, night routine 313 can be configured using a night routine template similar to the morning routine template as shown in FIG. 14. The table below illustrates an example of a night routine according to one embodiment. A night routine can be configured to cover any activities that may occur during a time period.

| Step | Individual Activity | Function | Type/Description |
|---|---|---|---|
| 0 | none | chime | Chime sound is invoked to get the |
| | | | Individuals attention for a |
| | | | scheduled routine, system is in day |
| | | | mode, prior to alarm time |
| 1 | none | routine | At scheduled time, “good night” |
| | | | routine is executed |
| 2 | Individual is notified by the system; | show-n-tell | Show SmartTab display visual and |
| | Visual Cue: presented text, “Hi Alexis, | | play TTS |
| | how did you feel today?”, along with | | |
| | “good” and “not good” selection buttons | | |
| | Audible Cue: plays TTS “Hi Alexis, how | | |
| | did you feel today?” over SmartTab | | |
| | display speakers | | |
| 3 | Individual is prompted to press button for | if | Test for button press |
| | “ . . . how did you feel today?” | | |
| | If “good” pressed, step 5 | | |
| | If “bad” pressed, step 30 | | |
| 4 | Individual presses “good” button | response | Individual button press |
| 5 | none | continue | Proceeds to next step in routine |
| 6 | Individual is notified by the system; | show-n-tell | Show SmartTab display visual and |
| | Visual Cue: presented text, “Alexis, | | play TTS |
| | would you like to go to sleep with some | | |
| | Lite Jazz?”, along with “yes” and “no” | | |
| | selection buttons | | |
| | Audible Cue: plays TTS “Alexis, would | | |
| | you like to go to sleep with some Lite | | |
| | Jazz?” over SmartTab display speakers | | |
| 7 | Individual presses “yes” button | response | Individual button press |
| 8 | Individual is presented with radio station | show | Show SmartTab display visual and |
| | (Lite Jazz) setup in configuration | | play TTS |
| | Visual: presented textual and | | |
| | graphical display of radio station | | |
| | stream | | |
| 9 | none | tablet | Set volume |
| 10 | none | tablet | Set brightness |
| 11 | none | HA Light | Turns off bedroom light |
| 12 | none | HA | Adjusts the home temp to a preset |
| | | thermostat | night level |
| 13 | none | timerSet | Timer set for 1 hour to play music, |
| | | | then set to end radio stream |
| 14 | none | timerExpire | Timer expires, routine proceed to |
| | | | next step |
| 15 | none | home | Tells android app to exit current |
| | | | screen and goto home screen |
| 16 | none | end | End of routine, terminates |
| | | | execution |
| | Branch from step 4 | | |
| 30 | Individual is prompted with | show | Show SmartTab display visual |
| | Visual Cue: presented text, “would | | |
| | you like to call someone?”, along | | |
| | with “yes’ and “no” selection | | |
| | buttons | | |
| 31 | Individual is prompted to press button for | if | Test for button press |
| | “ . . . call someone?” | | |
| | If “yes” pressed, step 40 | | |
| | If “no” pressed, step 32 | | |
| 32 | Individual presses “no” button | response | Individual button press |
| 33 | Individual is prompted by the system; | show | Show SmartTab display visual |
| | Visual Cue: presented text, “sorry | | |
| | you are not feeling well. Try to get | | |
| | some rest.”, along with “okay” | | |
| | button | | |
| | If “okay” pressed, step 10 | | |
| | Branch from step 32 | | |
| 40 | Individual is connected into a care group | call | System invokes call/message to |
| | call | | care group and connects as they |
| | | | accept or dial in. |
| | End of “good night” routine | | |

The activities or events of the night routine can be recorded and stored as a part of an event log, which can be analyzed subsequent by a machine-learning engine. The system can identify an optimum time for an individual to go to bed, in conjunction with “Good Morning” Adaptive Routine, dynamically change time over course of a few days to adjust to a better time set to improve sleep, etc., and identify over time through CareGiver feedback and “not good” button press that a call should be made instead of just a notification especially if the Individual has declined a call to someone (proactive contact).

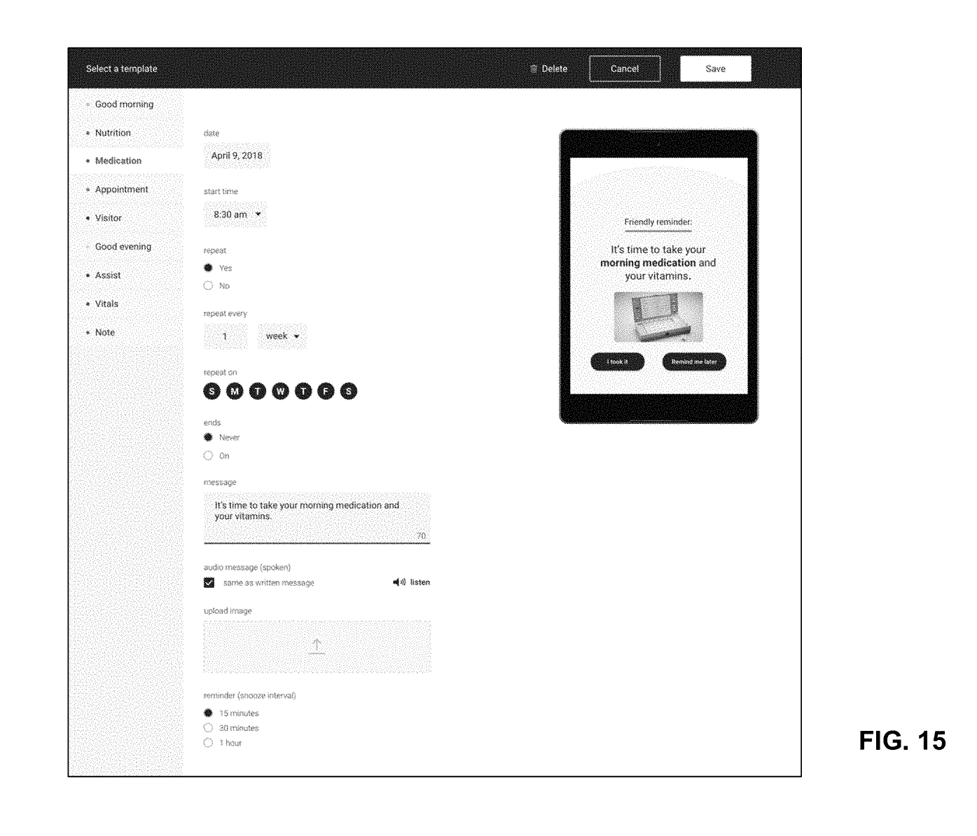

FIG. 15 is a screenshot illustrating an example of a graphical user interface for configuring a medication intake routine according to one embodiment. Referring to FIG. 15, which shows a medication routine template, an authorized person can set up the date and starting time of a medication routine, indicate whether the routine will be repeatedly executed, and which day of the week the routine will be repeatedly executed. A user can also specify a message transmitted to a primary user device and to be displayed thereon. A content item such as a media content (e.g., audio, image, video) can be uploaded, where the content item can be transmitted to the primary user device to be played thereon. The media content can be automatically converted by the system from the message entered therein, for example by clicking the checkbox of “same as written message.” In addition, a reminder interval can also be configured in response to a snooze response from the primary user. An example of the user interface or presentation that will be displayed at the primary user device is also shown on the right upper corner.

The table below illustrates an example of a medication intake routine according to one embodiment. A medication intake routine is designed to remind and keep track of a primary user to take proper medication during a period of time.

| Step | Individual Activity | Function | Type/Description |
|---|---|---|---|
| 0 | none | chime | Chime sound is invoked to get the |
| | | | Individuals attention for a |
| | | | scheduled routine |
| 1 | none | routine | At scheduled time, “meds” routine |
| | | | is executed |
| 2 | Individual is notified by the system; | show-n-tell | Show SmartTab display visual |
| | Visual Cue: presented text, “Hi Alexis, | | and play TTS |
| | it's time to take you <pill count>?”, along | | |
| | with “I took it” and “remind me later” | | |
| | selection buttons | | |
| | Audible Cue: plays TTS “Hi Alexis, it's | | |
| | time to take you <pill count>?” over | | |
| | SmartTab display speakers | | |
| 3 | Individual is prompted to press button for | if | Test for button press or event |
| | “ . . . time to take . . . ?” | | |
| | If “I took it” pressed, step 6 | | |
| | If pill door “opened” event, step 4 | | |
| | If “remind me later” pressed, step 10 | | |
| 4 | none | Med taken | Medfolio door open for meds |
| 5 | none | Goto step | Jump to step 7 in routine |
| 6 | Individual presses “I took it” button | response | Individual button press |
| 7 | none | continue | Proceeds to next step in routine |
| 8 | none | home | Tells android app to exit current |
| | | | screen and goto home screen |
| 9 | none | end | End of routine, terminates |
| | | | execution |
| | Branch from step 3 | | |
| 10 | none | timerSet | Timer set for 15 min |
| 11 | none | timerExpire | Timer expires, routine proceed to |
| | | | next step |
| 12 | Individual is notified by the system; | show-n-tell | Show SmartTab display visual |
| | Visual Cue: presented text, “Hi Alexis, | | and play TTS |
| | it's time to take you <pill count>?”, along | | |
| | with “I took it” selection button | | |
| | Audible Cue: plays TTS “Hi Alexis, it's | | |
| | time to take you <pill count>?” over | | |
| | SmartTab display speakers | | |
| 13 | Individual is prompted to press button for | if | Test for button press. |
| | “ . . . how did you feel today?” | | |
| | If “I took it” pressed, step 6 | | |
| | If pill door “opened” event, step 4 | | |
| | If NO response pressed or pill door | | |
| | event, step 14 | | |
| 14 | Individual presses does NOT press button or | response | Individual NO button press, |
| | the pill door was not opened | | Response page times out due to no |
| | | | response |
| 15 | none | No | Logs a timeout due to no button |
| | | response | press or pill door event |
| 16 | None | Goto step | Jumps to step 6 in routine |

The activities and events during the medication intake routine will be recorded and stored as a part of event log associated with the primary user. A machine-learning engine may be invoked to perform an analysis on the event log. The system can identify when notified if Individual is providing feedback after having taken required medication and specified times. The system can also identify time from notification(s) to feedback from Individual, dynamically change time over course of a few days to adjust to a better time set to improve feedback, and dynamic change also must be in sync with other meds and timed spacing between doses.

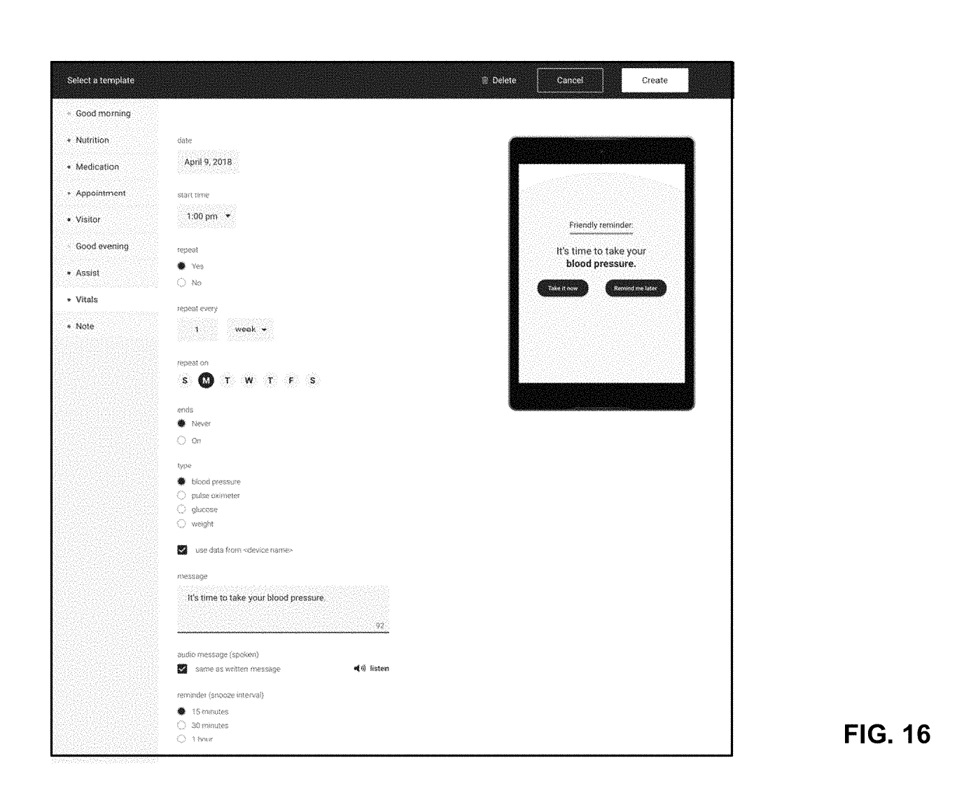

FIG. 16 is a screenshot illustrating an example of a graphical user interface for configuring a vital measure routine according to one embodiment. The user interface can be utilized to configure vital measurement routine 315. Referring to FIG. 16, an authorized person can set up the date and starting time of a vital measurement routine, indicate whether the routine will be repeatedly executed, and which day of the week the routine will be repeatedly executed. A user can also specify a message transmitted to a primary user device and to be displayed thereon. A content item such as a media content (e.g., audio, image, video) can be uploaded, where the content item can be transmitted to the primary user device to be played thereon. The media content can be automatically converted by the system from the message entered therein, for example, using text-to-speed (TTS) techniques, by clicking the checkbox of “same as written message.” In addition, one or more vital measurements such as blood pressure, pulse, glucose, and/or weight can be specified. An example of the user interface or presentation that will be displayed at the primary user device is also shown on the right upper corner.

The table illustrates an example of a vital measurement routine according to one embodiment. The vital measurement routine is configured to remind a primary user to measure certain types of vital status such as blood pressure, heartrate, weight, etc. The routine also records the measurement via the smart measurement devices.

| Step | Individual Activity | Function | Type/Description |
|---|---|---|---|
| 0 | none | chime | Chime sound is invoked to get the |
| | | | Individuals attention for a |
| | | | scheduled routine |
| 1 | none | routine | At scheduled time, “vitals” routine |
| | | | is executed |
| 2 | Individual is notified by the system; | show-n-tell | Show SmartTab display visual |
| | Visual Cue: presented text, “Hi Alexis, | | and play TTS |
| | it's time to take you | | |
| | <BP/weight/O2/Glucose/other>?”, along | | |
| | with “I took it” and “remind me later” | | |
| | selection buttons | | |
| | Audible Cue: plays TTS “Hi Alexis, it's | | |
| | time to take you | | |
| | <BP/weight/O2/Glucose/other>?” over | | |
| | SmartTab display speakers | | |
| 3 | Individual is prompted to press button for | if | Test for button press or event |
| | “ . . . time to take . . . ?” | | |
| | If “take it now” pressed, step 4 | | |
| | If “remind me later” pressed, step 20 | | |
| 4 | none | Vital taken | Device operation |
| 5 | Individual presses “take it now” button | response | Individual button press |
| 6 | Individual is instructed to put BP cuff on | BP taken | Pressure reading collected |
| | their arm and proceed with activating for | | |
| | reading | | |
| 7 | Vitals device stores reading | | Vitals device takes reading and |
| | | | pushes/syncs to their cloud for |
| | | | access via vendor portal and API |
| 8 | Vital devices cloud notification | | Vital devices cloud notifies |
| | | | Routinify system via API of new |
| | | | data |
| 9 | New data collect | | Routinify system requests data |
| | | | from vital devices cloud via API |
| | | | and stores in Routinify cloud for |
| | | | various uses |
| 6 | none | continue | Proceeds to next step in routine |
| 7 | none | home | Tells android app to exit current |
| | | | screen and goto home screen |
| 8 | none | end | End of routine, terminates |
| | | | execution |
| | Branch from step 3 | | |
| 10 | none | timerSet | Timer set for 15 min |
| 11 | none | timerExpire | Timer expires, routine proceed to |
| | | | next step |
| 12 | Individual is notified by the system; | show-n-tell | Show SmartTab display visual |
| | Visual Cue: presented text, “Hi Alexis, | | and play TTS |
| | it's time to take you | | |
| | <BP/weight/O2/Glucose/other>?”, along | | |
| | with “I took it” and “remind me later” | | |
| | selection buttons | | |
| | Audible Cue: plays TTS “Hi Alexis, it's | | |
| | time to take you | | |
| | <BP/weight/O2/Glucose/other>?” over | | |
| | SmartTab display speakers | | |
| 13 | Individual presses “take it now” button | response | Individual button press |
| 14 | Individual is instructed to put BP cuff on | BP taken | Pressure reading collected |
| | their arm and proceed with activating for | | |
| | reading | | |
| 15 | none | continue | Proceeds to next step in routine |
| 16 | none | home | Tells android app to exit current |
| | | | screen and goto home screen |
| | none | end | End of routine, terminates |
| | | | execution |

According to one embodiment, a nutrition routine such as nutrition routine 314 can be configured using a template similar to the template of morning routine 312 as shown in FIG. 14. The table below illustrates an example of a nutrition intake routine according to one embodiment. A nutrition routine is designed to remind a primary to take nutrition during the day such as meals.

| Step | Individual Activity | Function | Type/Description |
|---|---|---|---|
| 0 | none | chime | Chime sound is invoked to get the |
| | | | Individuals attention for a |
| | | | scheduled routine |
| 1 | none | routine | At scheduled time, “nutrition” |
| | | | routine is executed |
| 2 | Individual is notified by the system; | show-n-tell | Show SmartTab display visual and |
| | Visual Cue: presented text, “Hi Alexis, it's | | play TTS |
| | time to eat breakfast.”, along with “I ate” | | |
| | and “remind me later” selection buttons | | |
| | Audible Cue: plays TTS “Hi Alexis, it's | | |
| | time to eat breakfast.” over SmartTab | | |
| | display speakers | | |
| 3 | Individual is prompted to press button for | if | Test for button press |
| | “ . . . time to take . . . ?” | | |
| | If “I ate” pressed, step 4 | | |
| | If “remind me later” pressed, step 30 | | |
| 4 | Individual presses “I ate” button | response | Individual button press |
| 5 | none | continue | Proceeds to next step in routine |
| 6 | none | home | Tells android app to exit current |
| | | | screen and goto home screen |
| 7 | none | end | End of routine, terminates |
| | | | execution |
| | Branch from step 4 | | |
| 10 | none | timerSet | Timer set for 15 min |
| 11 | none | timerExpire | Timer expires, routine proceed to |
| | | | next step |
| 12 | Individual is notified by the system; | show-n-tell | Show SmartTab display visual and |
| | Visual Cue: presented text, “Hi Alexis, it's | | play TTS |
| | time to eat breakfast.”, along with “I ate” | | |
| | and “remind me later” selection buttons | | |
| | Audible Cue: plays TTS “Hi Alexis, it's | | |
| | time to eat breakfast.” over SmartTab | | |
| | display speakers | | |
| 13 | Individual is prompted to press button for | if | Test for button press |
| | “ . . . how did you feel today?” | | |
| | If “I ate” pressed, step 5 | | |
| | If NO response pressed, step 14 | | |
| 14 | Individual presses does NOT press button | response | Individual NO button press, |
| | | | Response page times out due to no |
| | | | response |
| 15 | none | noreponse | Logs a timeout due to no button |
| | | | press |
| 16 | None | Goto step | Jumps to step 6 in routine |

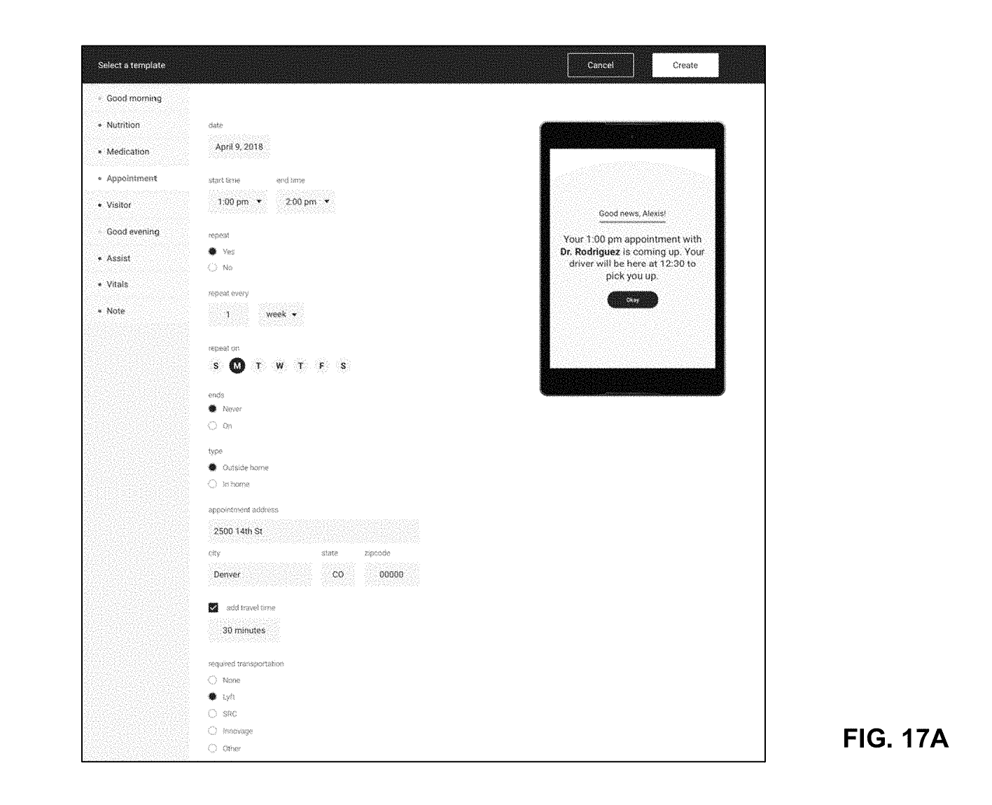

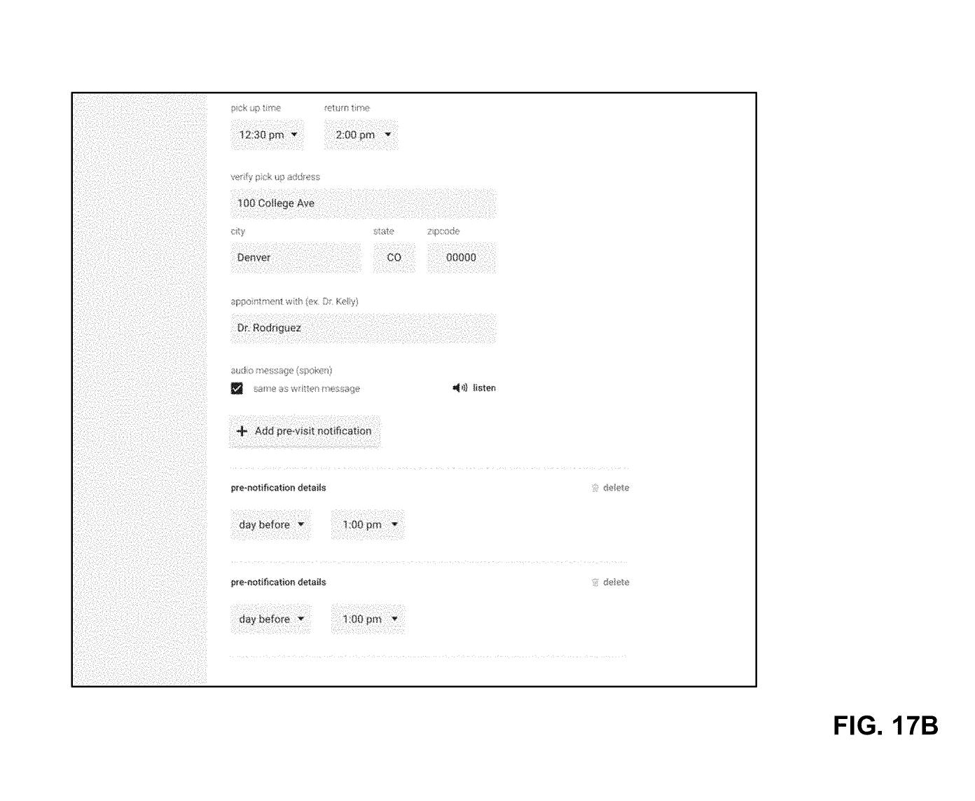

FIGS. 17A and 17B are screenshots illustrating an appointment template to configure an appointment routine such as appointment routine 316 according to one embodiment. Referring to FIGS. 17A and 17B, an authorized person can set up the date and starting and ending time of an appointment routine, indicate whether the routine will be repeatedly executed, and which day of the week the routine will be repeatedly executed. The user can also specify the location of the appointment, either on site or off site. The user may further specify the required travel time and the preferred transportation. The user can also specify the pickup time or return time, as well as the reminder schedule. An example of the user interface or presentation that will be displayed at the primary user device is also shown on the right upper corner.

Table below illustrates an example of an appointment routine according to one embodiment. An appointment routine is designed to set up an appointment for a primary user, remind the primary user about an upcoming appointment, and may arrange transportation for the appointment. A similar routine can be configured to remind a primary user that someone is about to visit the primary user premise based on the calendar data of the primary user.

| Step | Individual Activity | Function | Type/Description |
|---|---|---|---|
| 0 | none | chime | Chime sound is invoked to get the |
| | | | Individuals attention for a |
| | | | scheduled routine |
| 1 | none | routine | At scheduled time, “appointment” |
| | | | routine is executed |
| 2 | Individual is notified by the system; | show-n-tell | Show SmartTab display visual |
| | Visual Cue: presented text, “Hi Alexis, it's | | and play TTS |
| | time for your appointment with Dr. | | |
| | Kelly.”, along with “we met” selection | | |
| | button | | |
| | Audible Cue: plays TTS “Hi Alexis, it's | | |
| | time for your appointment with Dr. Kelly” | | |
| | over SmartTab display speakers | | |
| 3 | Individual is prompted to press button for | if | Test for button press |
| | “ . . . your appointment . . . ?” | | |
| | If “OK” pressed, step 4 | | |
| 4 | Individual presses “OK” button | response | Individual button press |
| 5 | none | continue | Proceeds to next step in routine |
| 6 | none | home | Tells android app to exit current |
| | | | screen and goto home screen |
| 7 | none | end | End of routine, terminates |
| | | | execution |
| | None | Goto step | Jumps to step in routine |
| | Goto step 5 | | |

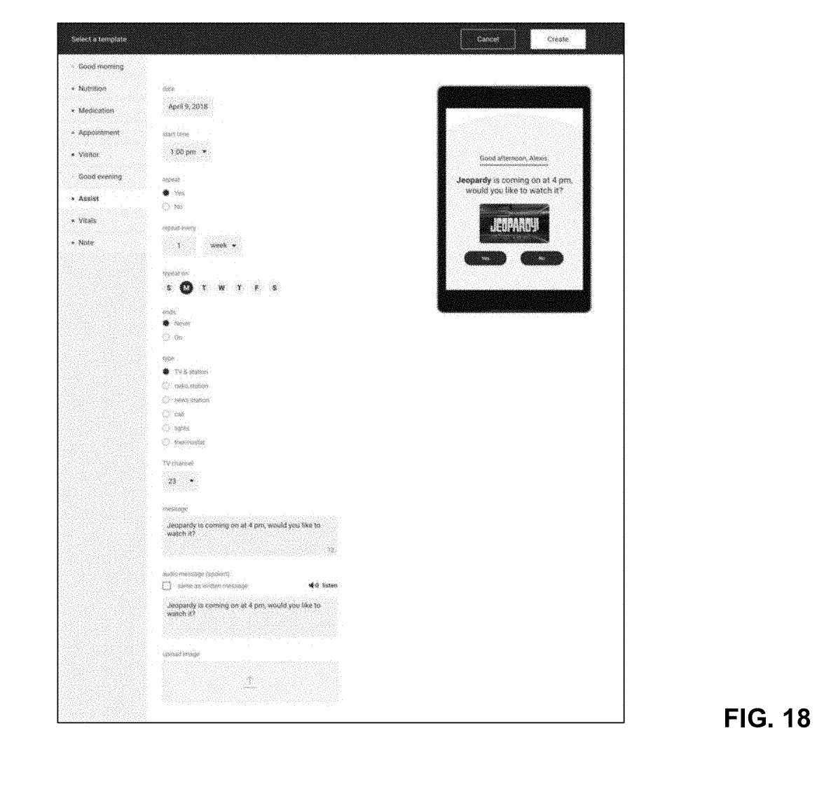

Table below illustrates an example of an assist routine. An assist routine is designed to help a primary user to perform certain actions, such as turning on/off TV, music, etc. A user interface for configuring an assist routine is shown in FIG. 18 according to one embodiment.

| Step | Individual Activity | Function | Type/Description |
|---|---|---|---|
| 0 | none | chime | Chime sound is invoked to get the |
| | | | Individuals attention for a |
| | | | scheduled routine |
| 1 | none | routine | At scheduled time, “assist” routine |
| | | | is executed |
| 2 | Individual is notified by the system; | show-n-tell | Show SmartTab display visual and |
| | Visual Cue: presented text, “Hi Alexis, | | play TTS |
| | Jeopardy is coming on at 4 pm, would you | | |
| | like to watch it?.”, along with “yes” and | | |
| | “no” selection buttons | | |
| | Audible Cue: plays TTS “Hi Alexis, | | |
| | Jeopardy is coming on at 4 pm, would you | | |
| | like to watch it?” over SmartTab display | | |
| | speakers | | |
| 3 | Individual is prompted to press button for | if | Test for button press |
| | “ . . . Jeopardy is coming on . . . ?” | | |
| | If “yes” pressed, step 4 | | |
| | If NO response pressed, step 8 | | |
| 4 | Individual presses “yes” button | response | Individual button press |
| 5 | Routinify API call | | Routinify system calls Harmony |
| | | | API with HTTP requests to |
| | | | perform |
| 6 | none | continue | Proceeds to next step in routine |
| 7 | none | HA TV On | TV is turned on |
| 8 | none | HA TV | TV is changed to channel for |
| | | Channel | jeopardy |
| 9 | none | home | Tells android app to exit current |
| | | | screen and goto home screen |
| 10 | none | end | End of routine, terminates |
| | | | execution |

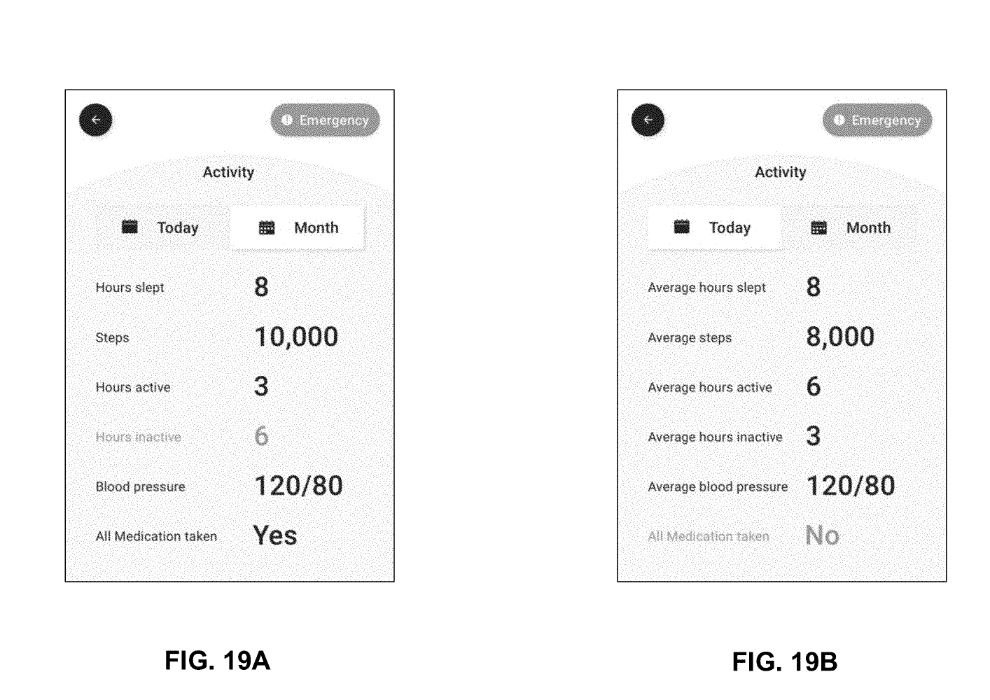

According to one embodiment, routine management system 101 further includes a user interface to allow any of the secondary users to query about the status or activities of any of the associated primary users at any point in time. In response to the query, analysis module 206 accesses the event log, compiles an activity summary for the requested primary user, and generates a report as shown in FIGS. 19A and 19B.

The interactions between a primary user and the routines are recorded and stored in an event log associated with the primary user. The system will utilize one or more selected third party Cloud Machine Learning (CML) engines for the purposes of enhancing the capabilities of each Adaptive Routine created specifically for automated, monitored, measured and managed environment to ensure that the Individual is safe and secure, to create and reinforce positive habits, and that loved ones and caregivers are comforted as they are well informed. In support of these positive habits, creating models to add learning insight and intelligence to Adaptive Routines in an individual environment is critical in developing Habits for Ageing Well. Each of the Adaptive Routines has a model that will be trained with specific data collected by the Routinify system by way of touch and voice driven interactive input between the system and individuals, sensors placed around the premise and the data they generate by individuals, wearable technologies to collect movement and activity data per individual, and medical devices to capture and store vitals per individual.

To utilize a model, model architecture will be designed and implemented onto the CML engine. The system must collect high-quality data from the Individuals environment and associated devices described above. This information will be stored in the system to drive model training and ongoing evaluation of changes in Individual data in real-time and batch modes. An API integration between the system and one of the selected CML engine partners in order to send collected high-quality data collected from Individuals and pass to the CML for evaluation against one or more models. Data can be passed via the API either in a real-time mode; as the data is collected it can be stored and forwarded to the CIVIL for evaluation, or in a batch package; for data to be evaluated but is not of a real-time nature or need.

Once the CML has evaluated the data, it will via the API send prediction information per model back to the system which can be used within the Adaptive Routines to enable a change in the behavior of an individual. If the data sent for analysis is of a real-time nature, the Adaptive Routine will act on the received prediction to make immediate changes, namely in the case of a medication, vital or nutrition Adaptive Routine. If the data sent for analysis is of a batch package nature, the Adaptive Routine will act on the received prediction to make near time or future changes, namely in the case of a good morning, good night, visitors and assist Adaptive Routine. Each model created is not a one and done creation. Each model, as additional data is sent, will continue to tune the predicted outcomes based on additional learnings from this data. Therefore the models are always learning and tuning predictive outcomes. As an individual changes or their environment changes, the models will adapt based on the continual data being fed from the system.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

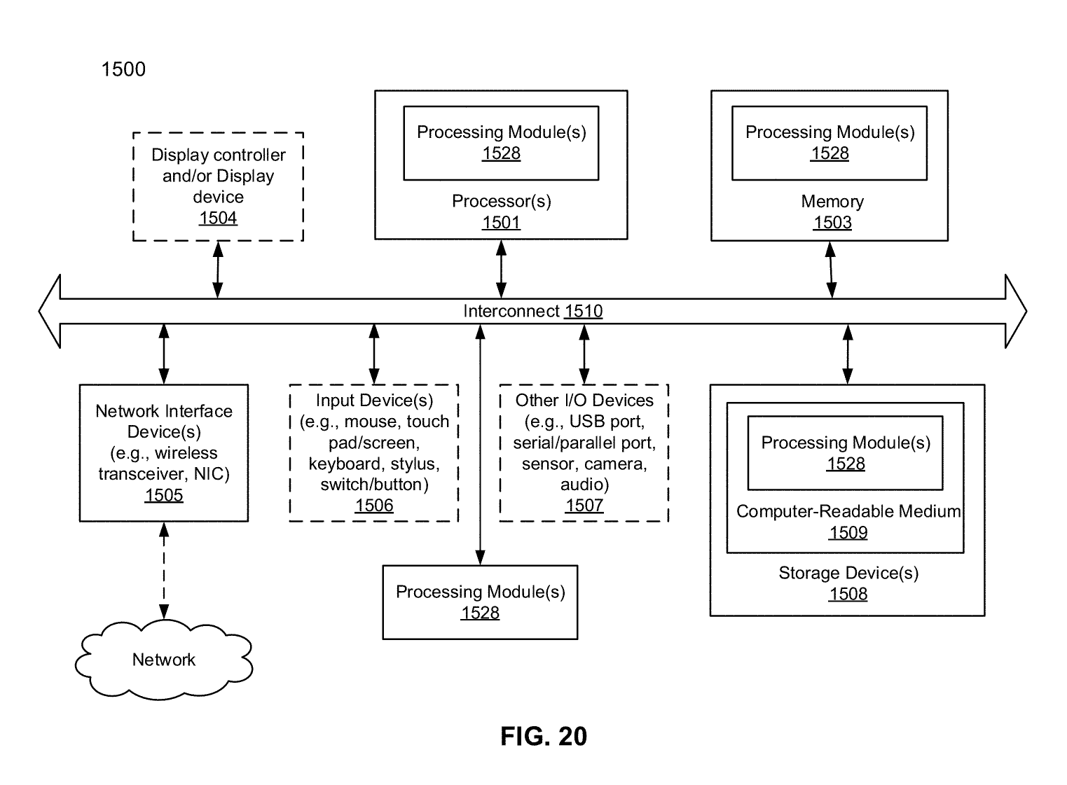

FIG. 20 is a block diagram illustrating an example of a data processing system which may be used with one embodiment of the invention. For example, system 1500 may represent any of data processing systems described above performing any of the processes or methods described above, such as, for example, a client device or a server described above, such as, for example, server 101, primary user devices 102, secondary user devices 103, or other servers 104, as described above.

System 1500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 1500 is intended to show a high level view of many components of the computer system. However, it is to be understood that additional components may be present in certain implementations and furthermore, different arrangement of the components shown may occur in other implementations. System 1500 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 1500 includes processor 1501, memory 1503, and devices 1505-1508 via a bus or an interconnect 1510. Processor 1501 may represent a single processor or multiple processors with a single processor core or multiple processor cores included therein. Processor 1501 may represent one or more general-purpose processors such as a microprocessor, a central processing unit (CPU), or the like. More particularly, processor 1501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 1501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 1501, which may be a low power multi-core processor socket such as an ultra-low voltage processor, may act as a main processing unit and central hub for communication with the various components of the system. Such processor can be implemented as a system on chip (SoC). Processor 1501 is configured to execute instructions for performing the operations and steps discussed herein. System 1500 may further include a graphics interface that communicates with optional graphics subsystem 1504, which may include a display controller, a graphics processor, and/or a display device.

Processor 1501 may communicate with memory 1503, which in one embodiment can be implemented via multiple memory devices to provide for a given amount of system memory. Memory 1503 may include one or more volatile storage (or memory) devices such as random access memory (RAM), dynamic RAM (DRAM), synchronous DRAM (SDRAM), static RAM (SRAM), or other types of storage devices. Memory 1503 may store information including sequences of instructions that are executed by processor 1501, or any other device. For example, executable code and/or data of a variety of operating systems, device drivers, firmware (e.g., input output basic system or BIOS), and/or applications can be loaded in memory 1503 and executed by processor 1501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 1500 may further include IO devices such as devices 1505-1508, including network interface device(s) 1505, optional input device(s) 1506, and other optional IO device(s) 1507. Network interface device 1505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 1506 may include a mouse, a touch pad, a touch sensitive screen (which may be integrated with display device 1504), a pointer device such as a stylus, and/or a keyboard (e.g., physical keyboard or a virtual keyboard displayed as part of a touch sensitive screen). For example, input device 1506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 1507 may include an audio device. An audio device may include a speaker and/or a microphone to facilitate voice-enabled functions, such as voice recognition, voice replication, digital recording, and/or telephony functions. Other IO devices 1507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 1507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 1500.

To provide for persistent storage of information such as data, applications, one or more operating systems and so forth, a mass storage (not shown) may also couple to processor 1501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 1501, e.g., via a serial peripheral interface (SPI). This flash device may provide for non-volatile storage of system software, including a basic input/output software (BIOS) as well as other firmware of the system.

Storage device 1508 may include computer-accessible storage medium 1509 (also known as a machine-readable storage medium or a computer-readable medium) on which is stored one or more sets of instructions or software (e.g., module, unit, and/or logic 1528) embodying any one or more of the methodologies or functions described herein. Processing module/unit/logic 1528 may represent any of the components described above, such as, for example, routine manager 115, as described above. Processing module/unit/logic 1528 may also reside, completely or at least partially, within memory 1503 and/or within processor 1501 during execution thereof by data processing system 1500, memory 1503 and processor 1501 also constituting machine-accessible storage media. Processing module/unit/logic 1528 may further be transmitted or received over a network via network interface device 1505.

Computer-readable storage medium 1509 may also be used to store the some software functionalities described above persistently. While computer-readable storage medium 1509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Processing module/unit/logic 1528, components and other features described herein can be implemented as discrete hardware components or integrated in the functionality of hardware components such as ASICS, FPGAs, DSPs or similar devices. In addition, processing module/unit/logic 1528 can be implemented as firmware or functional circuitry within hardware devices. Further, processing module/unit/logic 1528 can be implemented in any combination hardware devices and software components.

Note that while system 1500 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for executing routines associated with a user, the method comprising:
maintaining, at a server, one or more workflows for managing daily routines of a user located at a premise, each workflow having one or more workflow stages, each workflow stage being associated with a subroutine configured to be executed at a particular time of a day;
for each of the workflows, iteratively performing
determining a current time of a day,
identifying a workflow stage corresponding to the current time of the day,
executing a subroutine corresponding to the workflow stage, including
retrieving a content item corresponding to the workflow stage,
transmitting the content item to one or more preconfigured user devices of the user to be played thereon,
receiving a response from at least one of the preconfigured user devices representing a user response to the content item, and
logging the user response and timing of the user response in an event log storing user interaction history of the routine;
invoking a machine-learning engine to analyze the user interaction history in the event log to determine a user behavior of the user for each workflow; and
modifying at least timing of at least one subroutine of at least one workflow based on the user behavior.

2. The method of claim 1, wherein the content item comprises a wakeup alarm to wake up the user from sleeping, and wherein the method further comprises:
monitoring one or more motion sensors disposed at a plurality of locations within the premise;
receiving a signal from at least one of the motion sensors indicating the user has a motion action; and
recording a timestamp of the signal as a wakeup time of the user.

3. The method of claim 1, further comprising:
monitoring one or more motion sensors disposed at a plurality of locations within the premise;
in response to determining there is no motion action of the user for a predetermined period of time based on monitoring the motion sensors; and
transmitting the content item to the user devices to remind the user to move around.

4. The method of claim 1, further comprising:
monitoring a doorbell device of a front door of the premise over the network;
receiving a signal received from the doorbell device indicating that a visitor has arrived at the front door of the premise;
in response to the signal, accessing a calendar system associated with the user to determine whether an appointment has been scheduled around the current time of the day; and
transmitting the content item having information to the at least one user device to indicate whether a visitor is expected to visit the premise, in response to determining that an appointment has been scheduled.

5. The method of claim 4, further comprising:
receiving an image of the visitor from the doorbell device, wherein the image was captured by a camera of the doorbell device;
matching the image with contact information of the visitor scheduled to visit;
transmitting the contact information of the visitor to the at least one user device if there is a match.

6. The method of claim 1, wherein the content item comprises a reminder message to remind the user to take a predetermined medicine, and wherein the method further comprises:
monitoring a pill dispenser disposed within the premise over the network;
receiving a signal from the pill dispenser indicating a medicine pill has been removed from the pill dispenser; and
in response to the signal, recording time at which the medicine pill was removed.

7. The method of claim 6, further comprising
examining the signal to determine whether the medicine pill has been removed from a predetermined slot of the medicine pill dispenser associated with the current time of the day; and
transmitting a confirmation message to the at least one of the user devices to request the user to confirm whether a correct medicine pill has been taken.

8. The method of claim 1, wherein the content item comprises a reminder message to remind the user to take a vital measurement using a vital measurement device, and wherein the method further comprises:
receiving a measurement reading from the vital measurement device over the network; and
storing the measurement reading and time of the measurement in a database, wherein the vital measurement includes at least one of a blood pressure, heartrate, weight, or a sugar level measurement.

9. The method of claim 1, wherein the content item comprises a reminder message to remind the user to have a meal, and wherein the method further comprises:
sending a query to prompt the user for ingredient of the meal; and
in response to receiving the ingredient of the meal, storing ingredient information and time of the meal in a database.

10. The method of claim 1, wherein the content item comprises a reminder message to remind the user that there is an appointment scheduled at a particular point in time and prompt the user whether the user wish to arrange transportation, and wherein the method further comprises:
receiving a confirmation from the user for arranging transportation; and
in response to the confirmation, transmitting a request to a remote server to arrange a vehicle to pick up the user.

11. The method of claim 1, further comprising
accessing a calendar system associated with the user to determine whether an appointment has been scheduled within a predetermined proximity of the current time of the day;
transmitting a query to the at least one user device to query whether the user needs to arrange a transportation; and
in response to a positive response from the user device, transmitting a request to a third server over the network to arrange the transportation to the premise.

12. The method of claim 1, wherein the premise is an assisted living environment, and wherein the user is an ageing person residing in the assisted living environment.

13. A non-transitory machine-readable medium having instructions stored therein, which when executed by a processor, cause the processor to perform operations of executing routines associated with a user, the operations comprising:
maintaining, at a server, one or more workflows for managing daily routines of a user located at a premise, each workflow having one or more workflow stages, each workflow stage being associated with a subroutine configured to be executed at a particular time of a day;
for each of the workflows, iteratively performing
determining a current time of a day,
identifying a workflow stage corresponding to the current time of the day,
executing a subroutine corresponding to the workflow stage, including
retrieving a content item corresponding to the workflow stage,
transmitting the content item to one or more preconfigured user devices of the user to be played thereon,
receiving a response from at least one of the preconfigured user devices representing a user response to the content item, and
logging the user response and timing of the user response in an event log storing user interaction history of the routine;
invoking a machine-learning engine to analyze the user interaction history in the event log to determine a user behavior of the user for each workflow; and
modifying at least timing of at least one subroutine of at least one workflow based on the user behavior.

14. The machine-readable medium of claim 13, wherein the content item comprises a wakeup alarm to wake up the user from sleeping, and wherein the operations further comprise:
monitoring one or more motion sensors disposed at a plurality of locations within the premise;
receiving a signal from at least one of the motion sensors indicating the user has a motion action; and
recording a timestamp of the signal as a wakeup time of the user.

15. The machine-readable medium of claim 13, wherein the operations further comprise:
monitoring one or more motion sensors disposed at a plurality of locations within the premise;
in response to determining there is no motion action of the user for a predetermined period of time based on monitoring the motion sensors; and
transmitting the content item to the user devices to remind the user to move around.

16. The machine-readable medium of claim 13, wherein the operations further comprise:
monitoring a doorbell device of a front door of the premise over the network;
receiving a signal received from the doorbell device indicating that a visitor has arrived at the front door of the premise;
in response to the signal, accessing a calendar system associated with the user to determine whether an appointment has been scheduled around the current time of the day; and
transmitting the content item having information to the at least one user device to indicate whether a visitor is expected to visit the premise, in response to determining that an appointment has been scheduled.

17. The machine-readable medium of claim 16, wherein the operations further comprise:
receiving an image of the visitor from the doorbell device, wherein the image was captured by a camera of the doorbell device;
matching the image with contact information of the visitor scheduled to visit;
transmitting the contact information of the visitor to the at least one user device if there is a match.

18. The machine-readable medium of claim 13, wherein the content item comprises a reminder message to remind the user to take a predetermined medicine, and wherein the operations further comprise:
monitoring a pill dispenser disposed within the premise over the network;
receiving a signal from the pill dispenser indicating a medicine pill has been removed from the pill dispenser; and
in response to the signal, recording time at which the medicine pill was removed.

19. A data processing system, comprising:
a processor; and
a memory coupled to the processor to store instructions, which when executed by the processor, cause the processor to perform operations of executing routines associated with a user, the operations comprising:
maintaining, at a server, one or more workflows for managing daily routines of a user located at a premise, each workflow having one or more workflow stages, each workflow stage being associated with a subroutine configured to be executed at a particular time of a day;
for each of the workflows, iteratively performing
determining a current time of a day,
identifying a workflow stage corresponding to the current time of the day,
executing a subroutine corresponding to the workflow stage, including retrieving a content item corresponding to the workflow stage,
transmitting the content item to one or more preconfigured user devices of the user to be played thereon,
receiving a response from at least one of the preconfigured user devices representing a user response to the content item, and
logging the user response and timing of the user response in an event log storing user interaction history of the routine;
invoking a machine-learning engine to analyze the user interaction history in the event log to determine a user behavior of the user for each workflow; and
modifying at least timing of at least one subroutine of at least one workflow based on the user behavior.

20. The system of claim 19, wherein the content item comprises a wakeup alarm to wake up the user from sleeping, and wherein the operations further comprise:
monitoring one or more motion sensors disposed at a plurality of locations within the premise;
receiving a signal from at least one of the motion sensors indicating the user has a motion action; and
recording a timestamp of the signal as a wakeup time of the user.
